(19) United States
(12) Patent Application Publication
(10) Pub. No.: US 2013/0339168 A1
(43) Pub. Date: Dec. 19, 2013

(54) Systems and Methods for Facilitating Transactions Between a Seeker and a Proffered Provider of an Urgent Goods or Service

(71) Applicants: Keith T. White, Danville, CA (US); John L. Wray, Manassas, VA (US); Madeline A. Lombaerde, Belmont, CA (US)

(72) Inventors: Keith T. White, Danville, CA (US); John L. Wray, Manassas, VA (US); Madeline A. Lombaerde, Belmont, CA (US)

(21) Appl. No.: 13/910,831

(22) Filed: Jun. 5, 2013

Related U.S. Application Data
(60) Provisional application No. 61/657,018, filed on Jun. 7, 2012.
(60) Provisional application No. 61/657,013, filed on Jun. 7, 2012.
(60) Provisional application No. 61/657,015, filed on Jun. 7, 2012.

(51) Int. Cl. G06Q 30/06

(52) U.S. Cl. CPC G06Q 30/0601
USPC 705/26.1

(57) ABSTRACT

A computerized urgent goods and services fulfillment system facilitates followups between a seeker and a selected proffered provider of an urgent service or goods (URGS) requested by the seeker. The fulfillment system includes a server and a database for storing provider data. The server confirms that the URGS was provided by the selected proffered provider. The server then facilitates one or more followup transactions between the selected provider and the seeker, such as compensation or loyaltization. The server may also enable the seeker to update the provider's rating.

### CROSS REFERENCE TO RELATED APPLICATIONS

This non-provisional application claims the benefit of provisional application No. 61/657,018 filed on Jun. 7, 2012, entitled “Systems and Methods for Facilitating Transactions Between a Seeker and a Proffered Provider of an Urgent Goods or Service”, which application and is incorporated herein in its entirety by this reference.

This non-provisional application also claims the benefit of provisional application No. 61/657,013 filed on Jun. 7, 2012, entitled “Systems and Methods for Screening and Proffering Providers of an Urgent Goods or Service”, which application is incorporated herein in its entirety by this reference.

Additionally, this non-provisional application claims the benefit of provisional application No. 61/657,015 filed on Jun. 7, 2012, entitled “Systems and Methods for Matching a Seeker with a Proffered Provider of an Urgent Goods or Service”, which application is incorporated herein in its entirety by this reference.

### BACKGROUND

The present invention relates to systems and methods for selecting a proffered provider from a plurality of providers of an urgent goods or service requested by a seeker.

There are times when we travel—or even when we are close to home—that we have a near-emergency need for services and/or goods. Let's call such “really-need-to-have-now” services and goods: Urgently Required Goods and/or Services (URGS).

When we travel near home, much is familiar and URGS can be easy and quick to access—especially when we have located and acquired them previously or know someone who can give us pointers. But even in an age of standardization and globalization, traveling further from home is much more of an isolating experience where any services and goods are harder to locate and harder to acquire—especially URGS.

In some instances, we can pay for the convenience of having URGS brought to us. But due to cost-driven centralization and the separation of commercial, office and residential districts, we often need to locate, select, contact and travel to a remote locale to get the specific URGS we need.

Finding URGS can be a more critical and difficult problem than it might seem on first flush. Because time is of the essence, attempts that don't succeed are much harder to tolerate. Such missteps can cost us time, money, suffering and distress. Perhaps worse in a business situation, such time-wasting foul-ups can result in lost business opportunities; and in some instances, result in being punished or even fired.

While we might have had the help of relatives, subordinate coworkers, in-house specialists, or outside professional facilitators to help secure URGS, in today's personal and business environments, nearly everyone is expected to be self-reliant and calling on others for help is often viewed and treated negatively.

So given today's do-it-yourself environment, how might we accomplish acquiring URGS efficiently and effectively? First of all, based on our need, we need to figure out what the URGS are, and who—if anyone—provides the URGS we need. This search process is typically a repetitive one—where poking around, piecing together, weeding through, and then finally settling on an URGS provider based on partial information and our intuition is—at best—hit and miss. Often, we find we've made a less than optimal selection and end up lamenting: “if only I'd known”.

Although the mobile cellular telephone and the Internet make finding a variety of services and goods somewhat easier than print, billboard, Radio and TV ads lodged in our memory and yellow page telephone business directories, and landline telephones were the primary aids for locating URGS. Nonetheless, the process of locating and acquiring URGS can be a time-consuming and frustratingly complex process that is still largely fragmented, manual and ad hoc.

For example, one may live in Dallas Tex., but we have traveled on business to California's San Francisco Bay Area. Using an on-line travel and booking service, we pre-book a seemingly bargain-priced hotel in Fremont. Our flight into San Jose and subsequent car rental are uneventful, but what had been a twinge in our lower back before the flight has become an ominously painful cramping knot. We know where this is headed and it isn't good.

By the time we've gathered up the luggage, picked up the rental car, and driven to our hotel in Fremont, its 8 PM and we know we are in trouble. The pain is definitely getting worse. Thankfully, we have a smart phone that provides us Internet access nearly anywhere. The screen is ill suited to the vast majority of “full screen” web sites, but by “hunting and zooming”, we can navigate most any web site.

We Google “Emergency Chiropractor Fremont Calif.”, although the backache is not quite life threatening . . . yet. The pain slowly ramps up from agonizing to excruciating.

The first search result link title is “Emergency Chiropractor: $37”. The second is “$49 Chiropractic Emergency”. We cringe at the thought of going to a “bargain chiropractor”. The third result is “Fremont Emergency Back Care”, but tapping the link leads to the web site of a family osteopath with an unpronounceable name and nowhere is there mention of emergency services. Also, there are no patient ratings shown on the site. We call the number on the site and get an after-hours answering service. We ask for a number for the doctor and they decline. They take our number and say we'll get a call back. We don't get a call back until the next morning when the office opens.

The fourth search result is a Google map with seven red “map pins” shown in the vicinity of Fremont. Below it are the links corresponding to the red pins. The first is the unpronounceable osteopath again. Next is “Fremont Bones”. The web site has the motto “get crackin' . . . ”, and no mention of chiropractic emergencies. The third link is My Autism Team (huh ???). The fourth link is Dr. Paul Chiropractic Care—with lots of Google reviews. The Dr. Paul Dental Group apparently does Family and Herbal Wellness from four locations with 12 Doctors of Chiropractic mostly with exotic last names. We pull up the Google reviews—the hours are listed 9 AM-5 PM. The first reviews are glowing, but no mention of urgent treatment. Going deeper, there are a number of very negative reviews. One says “This doctor cannot fix my back problem. I visited another chiropractor, who was amazed by the workmanship of Dr. Paul's work.” Which reviews should we trust?

We decide on a brute force approach and just start dialing. We encounter answering machines, voice mail, disconnected numbers and answering services. Eventually, we get some return calls, and the confusion begins over insurance coverage. In exasperation, we decide to pay directly, but then the issue becomes non-cash payment. Finally, we set an appointment with a chiropractor who: 1) can be contacted, 2) is available, 3) is reasonably nearby, 4) seems acceptably qualified, and 5) agrees on payment. In the end, even with the aid of the Internet and a search engine, a great deal of time is consumed in a trial-and-error winnowing process.

Hence there is clearly is an unmet need for a service that assembles and pre-qualifies providers of URGS and pre-vets them for seekers of URGS requirements—meeting the criteria of both the seeker and of the potential providers—so as to offer the seeker a limited but highly-qualified set of URGS providers from which to choose.

### SUMMARY

To achieve the foregoing and in accordance with the present invention, systems and methods for matching seekers to providers of urgent goods and services is provided. In particular the systems and methods for screening and proffering a plurality of providers of an urgent service or goods requested by a seeker is provided.

In one embodiment, a computerized urgent goods and services fulfillment system is configured to provide at least one followup transaction for a seeker served by a selected proffered provider of an urgent service or goods requested by the seeker. The fulfillment system includes an urgent goods and services (URGS) fulfillment server and an URGS database configured to store provider data associated with the plurality of providers.

The fulfillment server is configured to confirm that an urgent service or goods (URGS) has been provided by a selected provider of at least one urgent service and goods proffered to a seeker. The server may enable the seeker to update the provider's rating.

The server also facilitates at least one followup transaction between the selected provider and the seeker. Followup transactions may include facilitating compensation, feedback from the seeker to the selected provider and/or instructions from the selected provider to seeker. The server may also facilitate loyaltization of the seeker and/or the selected provider, such as providing a reward or a discount, or increasing proffering preference of the selected provider.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is a System Level Block Diagram of one embodiment of an URGS Fulfillment System in accordance with the present invention;

FIG. 2 is an exemplary Top Level Logic Flow Diagram for the embodiment of FIG. 1;

FIG. 3 is a Logic Flow Diagram that further decomposes Step 230 of the Flow Diagram of FIG. 2;

FIG. 4 is a Logic Flow Diagram that further decomposes Step 340 of the Flow Diagram of FIG. 3;

FIG. 5 is a Logic Flow Diagram that further decomposes Step 240 of the Flow Diagram of FIG. 2;

FIGS. 6, 7 and 8 are exemplary screen images illustrating the Seeker experience in three different scenarios for the embodiment of FIG. 1;

FIG. 9 is an exemplary screen image illustrating the Seeker experience wherein the Seeker selects from a icon-based list of URGS for the embodiment of FIG. 1;

FIG. 10A is an exemplary screen image wherein the Seeker is proffered a set of proximate Providers as displayed as icons on a map for the embodiment of FIG. 1;

FIG. 10B is an exemplary screen image wherein the Seeker is proffered a set of proximate Providers as displayed as icons on a map and wherein one Provider is described by a pop-up sub-screen display for the embodiment of FIG. 1;

FIG. 11 is an exemplary screen image wherein the Seeker is offered two choices to contact the selected Provider—either phoning or texting—directly from the Seeker's terminal device for the embodiment of FIG. 1;

FIG. 12 is an exemplary screen image wherein a Provider is alerted of selection and likely contact by a new Seeker for the embodiment of FIG. 1;

FIG. 13A is an exemplary screen image wherein a map displays to a Provider the most recently determined Locales of Seekers who have selected that Provider for the embodiment of FIG. 1;

FIG. 13B is an exemplary screen image wherein a map displays to a Provider the most recently determined Locales of Seekers who have selected that Provider, wherein Seeker Locales have changed from FIG. 13A, for the embodiment of FIG. 1;

FIG. 14 is an exemplary screen image wherein the Seeker is proffered a set of proximate Providers as displayed as icons on a map for the embodiment of FIG. 1;

FIG. 15 is an exemplary screen image wherein the Seeker is offered two choices to contact the selected Provider—either phoning or texting—directly from the Seeker's terminal device for the embodiment of FIG. 1;

FIG. 16 is an exemplary screen image wherein a Provider is alerted of selection and likely contact by a new Seeker for the embodiment of FIG. 1;

FIG. 17A is an exemplary screen image wherein a map displays to a Provider the most recently determined Locale of a Seeker who has selected that Provider for the embodiment of FIG. 1;

FIG. 17B is an exemplary screen image wherein a map displays to a Provider the most recently determined Locale of a Seeker who has selected that Provider, wherein the Provider Locale has changed from FIG. 17A, for the embodiment of FIG. 1;

FIG. 18 is an exemplary screen image wherein the Seeker is proffered a set of proximate Providers as displayed as icons on a map, and wherein a location is displayed for a rendezvous, for the embodiment of FIG. 1;

FIG. 19 is an exemplary screen image wherein the Seeker is offered one choice to contact the selected Provider—by phoning—directly from the Seeker's terminal device for the embodiment of FIG. 1;

FIG. 20 is an exemplary screen image wherein a Provider is alerted of selection and likely contact by a new Seeker for the embodiment of FIG. 1;

FIG. 21 is an exemplary screen image wherein a map displays to a Provider the most recently determined Locale of a Seeker who has selected that Provider, and wherein the most recently determined Locale of the Provider is also displayed, for the embodiment of FIG. 1;

FIG. 22A is an exemplary screen image wherein the Seeker is proffered a set of proximate Providers as displayed as icons on a map for the embodiment of FIG. 1;

FIG. 22B is an exemplary screen image wherein the Seeker is proffered a set of proximate Providers as displayed as icons on a map, wherein the Provider Locales have changed from those in FIG. 22A, for the embodiment of FIG. 1;

FIG. 23A is an exemplary screen image wherein the Seeker is offered one choice to contact the selected Provider—by texting—directly from the Seeker's terminal device for the embodiment of FIG. 1;

FIG. 23B is an exemplary screen image wherein the Seeker is offered two choices to contact the selected Provider—either phoning or texting—directly from the Seeker's terminal device, wherein the Provider is different than the Provider in FIG. 23A, for the embodiment of FIG. 1;

FIG. 24 is an exemplary screen image wherein a Provider is alerted of selection and likely contact by a new Seeker for the embodiment of FIG. 1;

FIG. 25A is an exemplary screen image wherein a map displays to a Provider the most recently determined Locale of a Seeker who has selected that Provider, and wherein the most recently determined Locale of the Provider is also displayed, for the embodiment of FIG. 1;

FIG. 25B is an exemplary screen image wherein a map displays to a Provider the most recently determined Locale of a Seeker who has selected that Provider, and wherein the most recently determined Locale of the Provider is also displayed, and wherein the Locales of both the Seeker and the Provider have changed from FIG. 25A for the embodiment of FIG. 1; and

FIG. 26 is an exemplary screen image wherein a map displays to a Seeker the most recently determined Locales of both the Seeker the Provider that the Seeker has selected for the embodiment of FIG. 1.

### DETAILED DESCRIPTION

The present invention is described in detail with reference to selected preferred embodiments thereof as illustrated in the accompanying drawings. In the following description, numerous specific details are set forth in order to provide a thorough understanding of the present invention. It is apparent, however, to one skilled in the art, that the present invention may be practiced without some or all of these specific details. In other instances, well known technologies—such as World Wide Web operation, functionality of Internet-enabled mobile communication devices such as “smart phones”, and/or device-centric graphic user display techniques—have not been described in detail in order to not unnecessarily obscure the present invention. The features and advantages of the present invention may be better understood with reference to the drawings and discussions that follow.

The present invention relates generally to systems and methods for manipulating and utilizing data in a database or databases accessed over wide area networks (WANs) via any of a wide assortment of electronic network terminal devices. In particular, the present invention is directed to novel methods and systems to enable consumers with urgent needs (“Seekers”) to expeditiously locate, evaluate and acquire services and goods using devices such as, but not limited to, mobile communication devices; and for the vendors (“Providers”) of such urgently required good(s) and/or service(s) (“URGS”) to electronically offer them through a centralized enhanced automated directory service and to respond to Seekers requests for URGS via any of a wide assortment of electronic network terminal devices.

Of note is that, in the remainder of this application, particular attention is placed upon visual displays on a mobile communication device. It is important to realize that the present invention may apply equally well to operation with all manner of consumer electronic network terminal devices including, but not limited to, computers, tablet computer systems, e-reader devices, and virtually any electronic device which includes WAN access and a user interface. In addition, while examples of a visual interface are described in great detail, the present invention is entirely capable of operation with a wide range of interface types, including any combination of a visual display, tactile and audio output and a visual, tactile or acoustic user interface (UI). And although the present invention may utilize the PSTN for communication between Seeker and Provider, it may equally well utilize equivalent communication over other WANs using services such as, but not limited to, VoIP and Skype.

The present application for letters patent describes a directory, request processing and fulfillment agent system which interposes between database(s) and the user interfaces of electronic network terminal devices in such a way as to bring Seekers and Providers of URGS together virtually and/or physically in a timely fashion.

The present invention enables a Provider to adaptably conduct commercial activities such as: to advertise and offer URGS, detail the type of URGS provided, accumulate independent third-party assessments and reviews, display credentials, leverage the draw of a centralized need-targeted electronic directory, offer informative mini-tutorials and FAQs, update and display availability status, prequalify prospective Seeker customers, provide repeatable direct Seeker-Provider communication, arrange for commercial transactions, facilitate and track progress towards consummating commercial transactions, consummate commercial transactions for URGS and possibly other service(s) and/or good(s) with Seekers, follow-up post-transaction with Seekers to encourage and enhance good-will, and measure and evaluate the effectiveness of the foregoing and make adjustments and refinements.

Additionally, the present invention enables a unified adaptable facility for a Seeker to prequalify, locate, evaluate, make repeatable contact with, and acquire URGS from, one or several Providers.

Although at first consideration, the present invention may have some resemblance to generic search engines such as Google, it is much different in operation, function and result. Unlike a generic search engine, it uses a great deal of specificity—including Seeker- and Provider-sourced Profiles—in selecting a usably small set of well qualified results. Furthermore, it provides a much richer service that is tailored to urgent requirement fulfillment. When using a generic search engine, a user is generally anonymous and the user's motivations not apparent, and therefore the results provided are often voluminous, non-applicable, poorly differentiated, commonly misranked and generally of little or no use. The present invention on the other hand—based in part on information provided by a given Seeker specifically for this purpose—may pre-authenticate, validate, rank and otherwise screen Providers before responding with a vetted set of Providers in reply to that Seeker's specific request.

### I. Urgent Requirement Fulfillment System and Methods Thereof

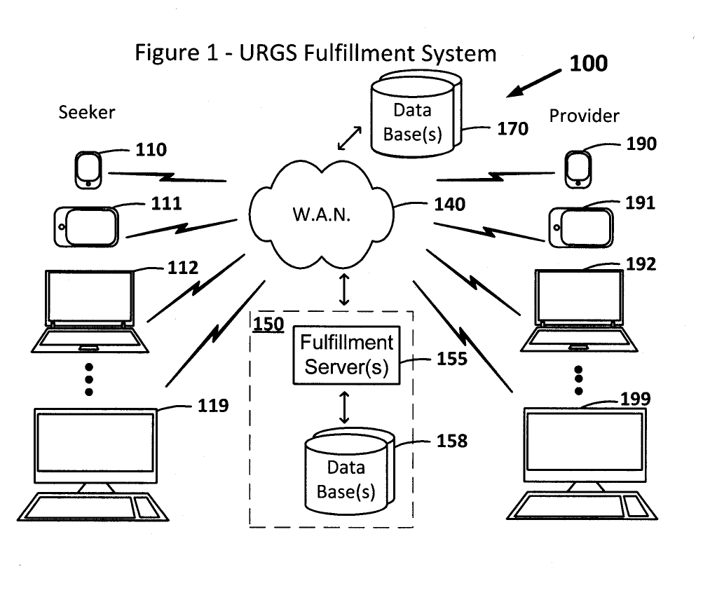

FIG. 1 provides a structural block diagram for an example of an Urgent Requirement Fulfillment System in accordance with an embodiment of the present invention. Such a Fulfillment System 150 may be accessed using a mobile communication device or any other electronic network terminal device with a user interface. For brevity, an electronic network terminal device may be referred to as a “terminal”, which can either be a dedicated purpose-built device or a suitable general purpose device.

The services of the Fulfillment System 150 are provided by the Fulfillment Server(s) 155, which utilize one or more Database(s) 158 containing information about users who can utilize the Fulfillment System 150 either as a Seeker or as a Provider. This distinction of two separate types of users does not prevent a user who is a Provider from also separately using the System 150 as a Seeker; nor does it prevent a Seeker from separately using the System 150 as a Provider. When describing use of the Fulfillment System 150 that is equivalent whether by a Seeker or by a Provider, the term “User” is used to mean either of these two types of users.

Seeker terminal choices, 110 through 119, represent the multiplicity of devices that can support access to the Fulfillment System 150. Often these terminals are mobile communication devices—i.e., devices that can be carried easily from place to place by the Seeker—typically with Wi-Fi or cellular data or other wireless connectivity and in numerous instances with built-in mobile telephone capability. However, less portable or fixed installation terminals may also support access to the Fulfillment System 150.

Provider terminal choices, 190 through 199, mirror the choices available to a Seeker. They differ specifically in the role of the User, i.e., Provider rather than Seeker, and the specific device chosen by each individual User. So for instance a given Seeker may use a “smart phone” mobile communication device, 110, whereas a Provider may use a desktop computer, 199.

In some embodiments, a Seeker or Provider's use of the Fulfillment System 150 is not bound to a specific terminal device, so for instance a Seeker could initially access the Fulfillment System 150 using a laptop computer, say from home, and subsequently use the Fulfillment System 150 with a tablet computer, while traveling in a car.

In some instances, a User's electronic network terminal device that is dedicated to providing data access, e.g., a desktop computer, 119/199, may be augmented for telephone communication by a separate telephony device (not shown) and/or third party telephony software (not shown) running on the terminal device. Such separate telephony devices may include, but not be limited to: a mobile cellular phone or a landline telephone, or a headset paired with third party telephony software running on the terminal device, e.g., Skype.

At the level of network connectivity, a Seeker's terminal and a Provider's terminal operate in equivalent ways, therefore for simplicity: the terms “User's” device or “User's” terminal is used when operation of a Fulfillment System 150 feature applies in the same fashion to either a Seeker's terminal or a Provider's terminal device.

Inter-communication between a User's terminal device and the Fulfillment System 150 may use a Wide Area Network (WAN), 140, such as the Internet. Communication between a User and the Fulfillment System 150, or between a Seeker and a Provider, may involve traversing more than one WAN (not shown). In some embodiments, Fulfillment System-facilitated communication between a Seeker and a Provider may also involve a WAN or WANs such as the PSTN and/or the Internet.

The Database(s) 158 used by the Fulfillment System 150 may be centralized or distributed. In some embodiments, the Fulfillment System 150 is coupled to one or more external database(s) 170 via WAN 140.

Generally, the Database 158 used by the Fulfillment System 150 is remote from the User's terminal; however in some embodiments, portions of database(s) used by the System 150 may reside on the User's electronic terminal device (not shown).

Depending on the embodiment, the Fulfillment System 150 may use one or several models of connectivity including, but not limited to: client/server and peer-to-peer. Client/server connectivity may use a WAN such as the Internet for access between the User's terminal device and the Fulfillment System's server(s) 155. Peer-to-peer connectivity, such as a Fulfillment System-facilitated telephone call or text message exchange between a Seeker and a Provider, may typically also use a WAN such as the PSTN or the Internet.

In some embodiments, communication between a Seeker and a Provider may be intermediated by the Fulfillment System 150. In such intermediation—sometimes referred to as “proxying”—the System 150 may source, receive, reroute, multicast, broadcast or otherwise initiate or respond to and/or terminate communication: from a Seeker (or on a Seeker's behalf) intended for a Provider, and/or; from a Provider (or on a Provider's behalf) intended for a Seeker. In addition, the System 150, may translate, clarify, expand, simplify, repeat, and/or generally modify or enhance the content communicated between Users in such a way as to improve or enhance comprehension or to increase the likelihood of successful completion of the communication. Such intermediation services may have varying mixes of automation and/or direct human participation depending on the embodiment.

Additionally, the Fulfillment System 150 may translate, clarify, expand, simplify and otherwise modify or enhance what is communicated. At a signal content level, the System 150 may amplify, filter, encode, decode, transcode, compress, expand, error correct and generally process the signal corresponding to the communication in ways well understood to one well versed in the art.

In some embodiments, voice communication may be intermediated by the Fulfillment System 150 in such a way that the telephone number(s) nominally routed directly to a User are actually directed to and/or are routed by the System 150. For example, the Fulfillment System 150 may provide additional services to a Provider or on a Provider's behalf including, but not limited to: PBX services including call routing/forwarding, call attendance, voice mail, call center and client notifications by outgoing call.

In some embodiments, data communication may be intermediated by the Fulfillment System 150 in such a way that logical network addresses—e.g., web site URLs and email addresses—nominally routed directly to a User are actually routed to and/or sourced from and/or redirected by the System 150. For example, the Fulfillment System 150 may provide additional services to a Provider or on a Provider's behalf including, but not limited to: Web site, email, blog, on-line forum/social network posts, electronic newsletters, and push notifications to clients.

In some embodiments, text messaging communication may be intermediated by the Fulfillment System 150 in such a way that logical texting addresses—e.g., Universal Resource Identifiers—nominally routed directly to a User are actually routed to and/or sourced by and/or redirected by and/or translated by the System 150. For example, the Fulfillment System 150 may provide additional services to a Provider or on a Provider's behalf including, but not limited to: text-email translation, text-voice translation, system-to-system gateway (e.g., between SMS and IM) and push text messaging notifications to clients.

A number of third parties, such as Better Business Bureau, Chamber of Commerce, professional/trade organizations and consumer rating sites—e.g., Angie's List and 1800Dentist—maintain large databases describing service vendors. In some embodiments, the Fulfillment System 150 may use data from such third party databases and/or from Users' terminal devices. Hence, Seekers have access to a very wide variety of Providers listed in a virtual aggregate database or virtual composite database comprised of Database 158 plus data accessed or acquired from third parties plus data stored on or acquired from Users' terminal devices. For simplicity in the following description, we refer to representative Database 158.

A large number of third parties, such as telephone companies, business journals, professional associations, and business directory companies—e.g., yp.com—maintain directories of service vendors as a business. In some embodiments, the Fulfillment System 150 may redirect certain Seekers to third party directory sites; or the System 150 may display contents from third party sites to Seekers. Motivations to do so may include, but not be limited to: Seeker requires non-urgent service, the third party pays for referrals, no suitable Providers are found in the Database 158 for the URGS the Seeker requires.

Elemental to the operation of the Fulfillment System 150 is User-descriptive data entered into the Database 158 voluntarily by Seekers and Providers themselves. In some embodiments, this data may be augmented with data from third parties, which may be copied or simply utilized on a one-time basis. Such User-descriptive data for a given User may be referred to as a “Profile” or for multiple Users or in aggregate—“Profiles”.

Profiles may be stored in Database 158 and can be organized, portioned, sorted, encrypted, firewalled, access-restricted, backed-up, transaction logged and otherwise managed, maintained and protected using techniques familiar to one skilled in the art.

In general, industry best practices are applied so as to comply with any legal mandates, regulatory requirements, or industry consensus on the protection of private, sensitive and proprietary information or otherwise privileged information. So for instance when a Profile includes or the System 150 accesses a User's medical records, appropriate HIPPA standards are complied with. Encryption may be applied to protect information in the Database 158 and also protect information communicated between Users and the System 150 and/or third parties and the System 150. In many embodiments, encryption may occur as appropriate using technologies familiar to one well versed in the art, such as Secure Sockets Layer (SSL), Transport Layer Security (TLS) and Virtual Private Network (VPN).

In some embodiments, Seekers' Profiles may describe things such as their creditworthiness, their employment, their recent purchases, their property, their health, their physical and work addresses, their phone number(s), their email address(es), and similar descriptive information that may assist in determining whether a given Seeker is someone a given Provider might want to do business with. The Fulfillment System 150 may automatically and transparently vet some Seekers so as to preempt a potential match with a Provider. In other instances, portions of a Seeker's Profile may be viewable to a Provider to assist that Provider in deciding whether to do business with a given Seeker.

In the case of Providers, their Profiles may describe details such as their qualifications and specializations, their education and training, their credentials and licenses, their professional memberships and associations, their career histories, their work philosophies, languages they may speak, as well as more prosaic information such as a business address, telephone number and email address.

In a typical embodiment, a User's Profile may specify requirements that User has for transacting commerce with their counterpart User—i.e., a Seeker with a given Provider; and a Provider with a given Seeker. So for instance, a Seeker may indicate what form of payment they wish to have accepted, what awards programs they wish to have credited, what language they prefer to be spoken to them, and other details of how they prefer or require a transaction to be conducted. Similarly, a Provider may indicate what form of payment they are willing to accepted, what awards programs they support, what language(s) they speak, and other details of how they prefer or require a transaction to be conducted.

Sources for information in a User's Profile may include, but are not limited to: the User directly, private records from third parties (possibly with the User's permission), and publicly accessible records. Some Profile information may be placed into the Database 158 and not be updated for indeterminate periods of time. Other Profile information may have a specific “time to live” after which it is either updated or simply deleted. The shortest such “time to live” may be per access. Other Profile information may be sourced from a User or a third party on a per use basis. This may be done for instance because the sources prohibit retaining copies of it, or because there is a need to get the most up-to-date information, e.g., checking criminal records.

Information in a User's Profile may be beneficial or derogatory. The information in a Provider's Profile is generally there for the use of Seekers. Similarly, the information in a Seeker's Profile is generally there for the use of Providers. Consequently, even if a User can enter or view an item of information in their Profile, they may not necessarily be able to alter or delete it.

Some information in a Provider's Profile may be entered by Seekers—typically in the form of ratings. Similarly, a Seeker's Profile may contain information entered by Providers. Additionally, third parties may source some information in a User's Profile. In some instances, such ratings or characterizations may be unsolicited or gathered as part of a follow-up instigated by the Fulfillment System 150.

Profiles for Seekers contain generally different information than, and are commonly kept separate from, Profiles for Providers. In the instance where a User is both a Seeker and (separately) a Provider, the contents of the User's Seeker and Provider Profiles are typically not intermingled. Of course, some User information may be duplicated in both Profiles, for example the User's name.

Some portions of a User's Profile may be used strictly internal to the Fulfillment System 150 or for the purposes of operators of the Fulfillment System and never be visible to any Users—Seeker or Provider—nor utilized on their behalf by the System 150.

Some Seeker Profile information may be visible to a Provider or to the Fulfillment System 150 on a Provider's behalf, but not visible to that Seeker. Similarly, some Provider Profile information may be visible to a Seeker or to the System 150 on a Seeker's behalf, but not visible to that Provider.

Some of the Profile information of a Seeker may be visible to other Seekers. For example, in some embodiments limited Profile information may be viewable via an on-line user forum that is part of the Fulfillment System 150.

A User who is a Provider may conceivably offer several different types of URGS as separate businesses. The Fulfillment System 150 may allow multiple Provider Profiles for such a User, where some of the information in the Profiles is duplicated in each Profile and other information is unique to a Profile specific to the corresponding URGS provided. In some embodiments, such Profiles may be accessed using separate unique accounts.

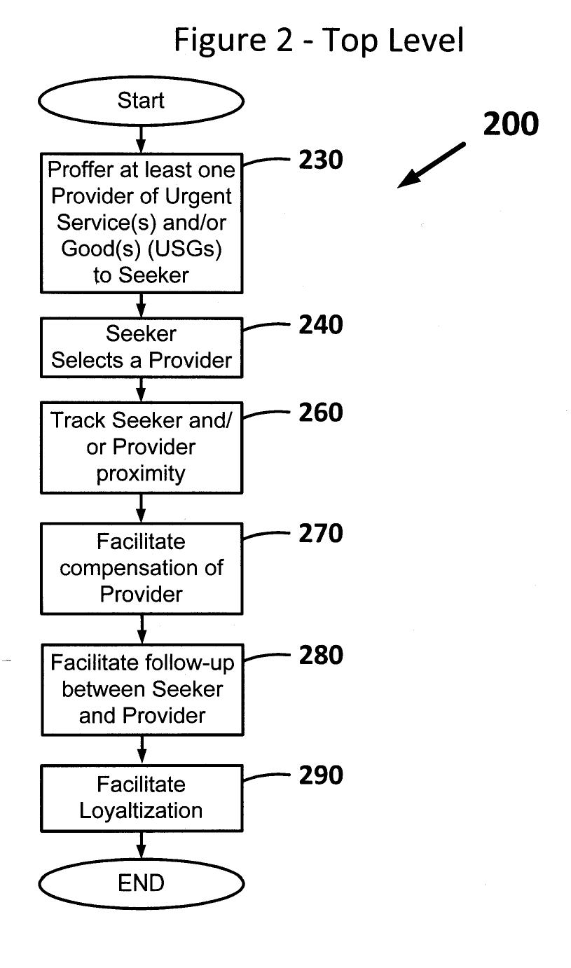

Referring to FIG. 2, the Fulfillment System 150 may serve to fulfill a Seeker's need for URGS using a winnowing and matching process that commonly results in the Seeker being paired with a well suited Provider that the Seeker selects from a list of qualified potential Providers. FIG. 2 illustrates the process used in some embodiments. Steps appearing in FIG. 2 are illustrated by several different examples in the discussions that follow.

In step 230, the Fulfillment System 150 prepares to proffer a set of potential Providers to the Seeker. Substantial amounts of information about the Seeker and about potential Providers may be retrieved from the Database 158 and utilized by the System 150 to either validate or reject potential pairings of the Seeker to proximate Providers.

As mentioned above, both the Profiles of the Seeker and potential Providers may contain requirements that are mandatory qualifiers as well as other requirements that reflect non-mandatory preferences. Accordingly, some embodiments may apply weightings to Profile preferences and instantiate rankings of potential Providers based on the degree of “acceptability” or “goodness” of a given Provider as determined algorithmically based on Seeker and Provider Profiles, third party ratings, and other external data. In some embodiments, the ranking of potential Providers may be displayed for the Seeker's use (not shown herein) prior to selecting a Provider. A given Provider's ranking may be represented by a color code, icon size, some number of stars, a ranking number, or any of a multiplicity of indicators of relative rank familiar to one skilled in the art. In some embodiments and some instances, there may be more potential Providers than is practical to proffer. In some embodiments, the Fulfillment System 150 may limit the number of potential Providers proffered to a number lower than the total available. In such instances, the ranking of a given Provider—relative to other potential Providers—may determine whether or not that Provider is proffered.

Some of the Profile information of a User may affect other aspects of Fulfillment System 150 operation and use. For example, language preference may cause the System 150 to generate displays in a language suited to the User. A “zooming” feature and/or audio dialog may support the visually impaired. A multiplicity of behaviors—System 150 operation in general and display operation specifically—may be influenced by User Profile preference settings.

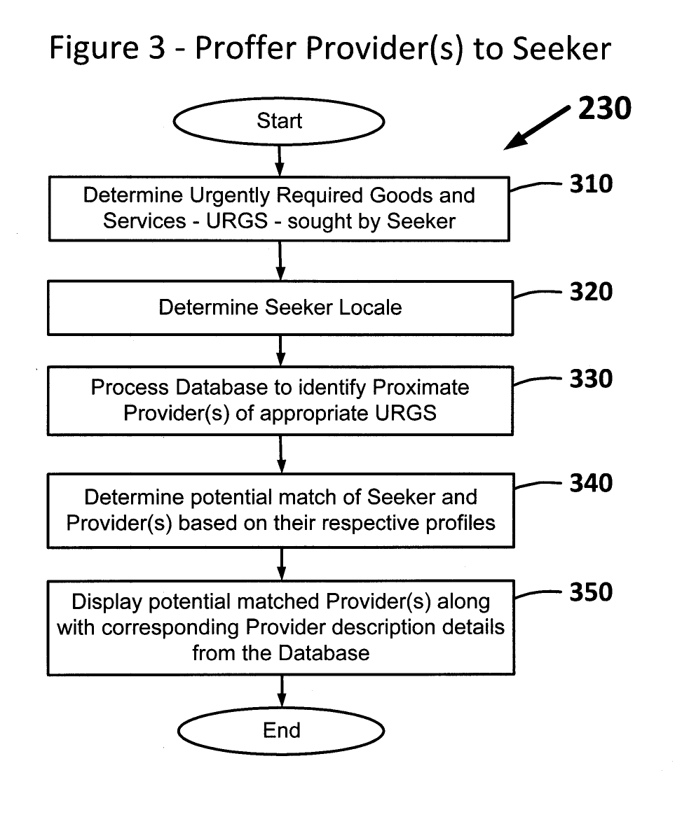

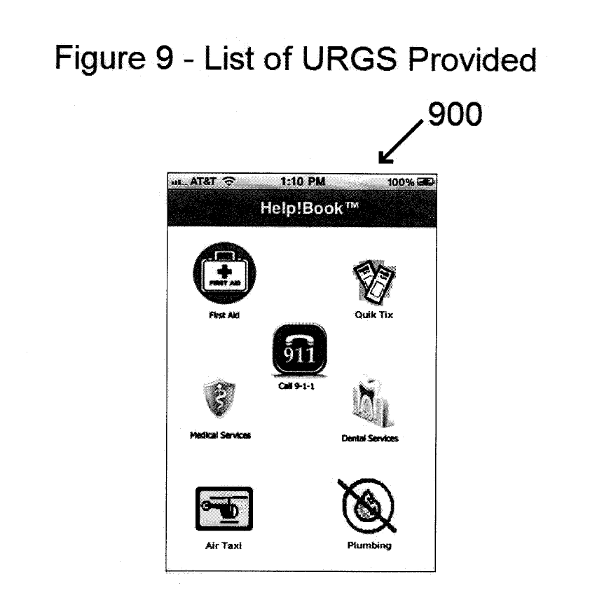

FIG. 3 shows step 230 in greater detail. Referring to step 310, the Fulfillment System 150 determines the URGS sought by the Seeker. In some embodiments, this is accomplished by offering a list of the URGS to select from. In some embodiments, such a list may be in the form of graphic icons—as in FIG. 9. Other embodiments, which may support substantial numbers of URGS, may provide various facilities to allow a Seeker to locate and select the URGS sought—for instance, key word search.

As shown in step 320 of FIG. 3, the Fulfillment System 150 determines the Seeker's Locale. The Seeker's Locale may be determined in a multiplicity of ways depending on a variety of factors including but not limited to: the type of URGS sought by the Seeker; whether the Seeker is required to travel to a rendezvous location to acquire the URGS; whether the Seeker can not or does not want to travel. The Seeker's Locale may be determined around the time that the Seeker utilizes the System 150 to seek URGS or it may be previously determined. So for instance, the Seeker's Locale may be taken to be the Seeker's home or place of work as defined by the Seeker's Profile in the Database 158. Or the Seeker's Locale may be taken to be the expected location of the Seeker based on a schedule defined by the Seeker's Profile in the Database 158. Or the Seeker's Locale may be taken as a geo-location provided by the Seeker or by a mobile communication device in the Seeker's possession or by a third party geo-location service such as a telephone service company, a security surveillance company, or other organizations that utilize or commerce in the geo-location of individuals to conduct their own business and/or facilitate the businesses of others.

Information from the Seeker's Profile may include preferences that affect how the Seeker's Locale is determined. In many embodiments, the Fulfillment System 150 displays information reflecting the Fulfillment System 150's calculation of the Seeker's Locale (not shown)—allowing the Seeker to determine if the Fulfillment System 150 has made a mistake in attempting to establish a Locale for the Seeker.

Having ascribed a Locale to the Seeker, in Step 330 the Fulfillment System 150 processes the Database 158 to identify proximate Provider(s) of the URGS sought by the Seeker. Proximity typically involves measuring between locations. As relates to URGS fulfillment, those locations commonly correspond to the Seeker's Locale and to the Provider's Locale. Where the Seeker's Locale or a given Provider's Locale may be ascertained to be—for the purpose of determining proximity—can depend on a number of factors. In some instances, determination of proximity may be affected by preferences in the Seeker's Profile in the Database 158 and/or in a given Provider's Profile in the Database 158. For example, a given Provider's Profile preference may require the rendezvous location and/or the Seeker's Locale to lie within a specific region or territory based on the strictures of a License or Certificate or third party permission issued to that Provider. If that preference is not met, the Provider is determined by the Fulfillment System 150 to not be proximate to the Seeker.

Proximity may also have temporal determining factors. For instance, a potential Provider may be relatively near a Seeker, but have prior commitments that must be seen to first. Or for example, bad traffic may slow the time it takes to travel to a rendezvous location. In an urgent situation, temporal proximity may be more important than physical proximity. In many embodiments, the Fulfillment System 150 may ascribe proximity to a given Provider based on a multiplicity of temporal-related factors including, but not limited to: projected travel route, third party traffic congestion and weather reports, historical traffic patterns and records, and Provider promptness ratings. In some instances, factors impacting temporal proximity may not be apparent to the System 150 such that communication between the Seeker and a Potential Provider may indicate a different—perhaps less attractive—temporal proximity.

For the purposes of Step 330, the Provider's Locale may be ascribed in a number of different ways depending on numerous factors including but not limited to: the type of URGS provided; whether the acquisition of the URGS requires the actual physical presence of the Provider and/or of the Seeker; whether the Provider operates from a fixed business location; and/or whether it is necessary for the Provider to travel to provide the URGS. So for instance, the Provider's Locale may be taken to be the Provider's place of business as defined by the Provider's Profile in the Database 158. Or the Provider's Locale may be taken to be the expected location of the Provider based on a schedule defined by the Provider's Profile in the Database 158. Or the Provider's Locale may be taken as a geo-location provided by the Provider or by a mobile communication device in the Provider's possession. Information from the Provider's Profile may include preferences that affect how the Provider's Locale is determined.

In many embodiments, the information: URGS sought, Seeker's Locale, and each Provider's availability and Locale is deemed sufficient to allow the Fulfillment System 150 to process the Database 158 to identify proximate Provider(s) of the sought after URGS—see 330.

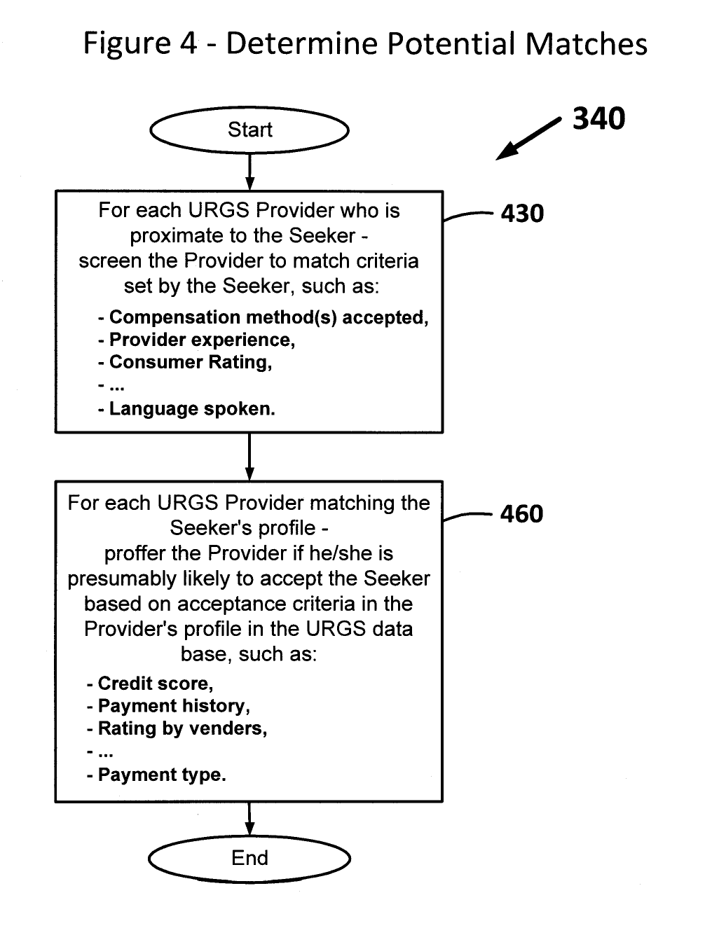

In many embodiments, additional winnowing of the set of potential Provider's may occur based on additional preferences a Seeker has indicated in their Profile and/or additional preferences a given Provider has in theirs—reference 340. FIG. 4 provides instances of some additional Seeker and Provider criteria—430 and 460, respectively—that in some embodiments may serve to further cull the set of potential Providers.

In some embodiments, the Fulfillment System 150 may attempt to winnow down the set of potential Providers. In 350, the Fulfillment System 150 may present the resulting set of potential Providers to the Seeker. In some embodiments, the System 150 may modulate the winnowing process so as to proffer at least two potential Providers.

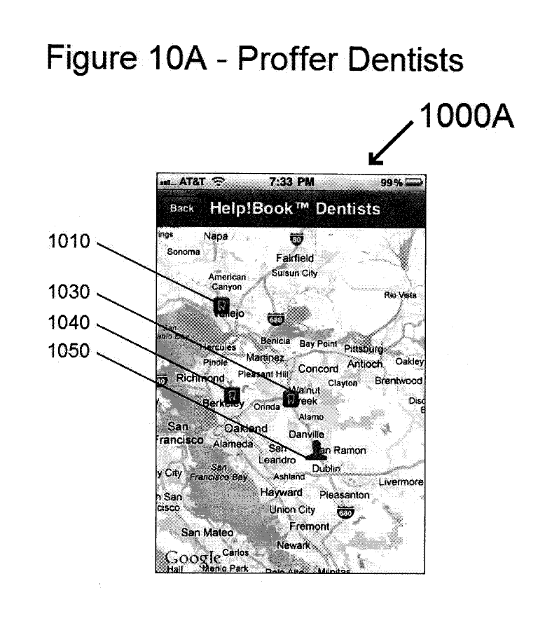

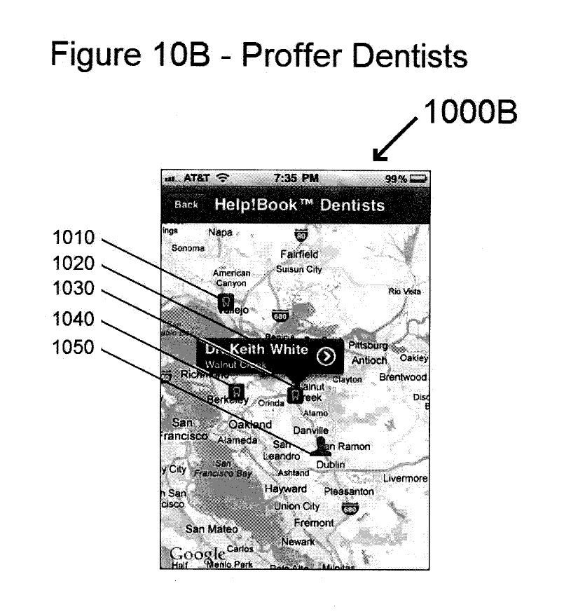

In some embodiments, the set of potential Providers is displayed on a map that shows their approximate Locales and their relative proximity to the Seeker—see FIG. 10A for an example. In some embodiments, a Seeker may further open a pop-up subscreen to view additional Provider details—see 1020 in FIG. 10B.

Referring to 240—the Seeker typically selects one of the Providers proffered by the Fulfillment System 150.

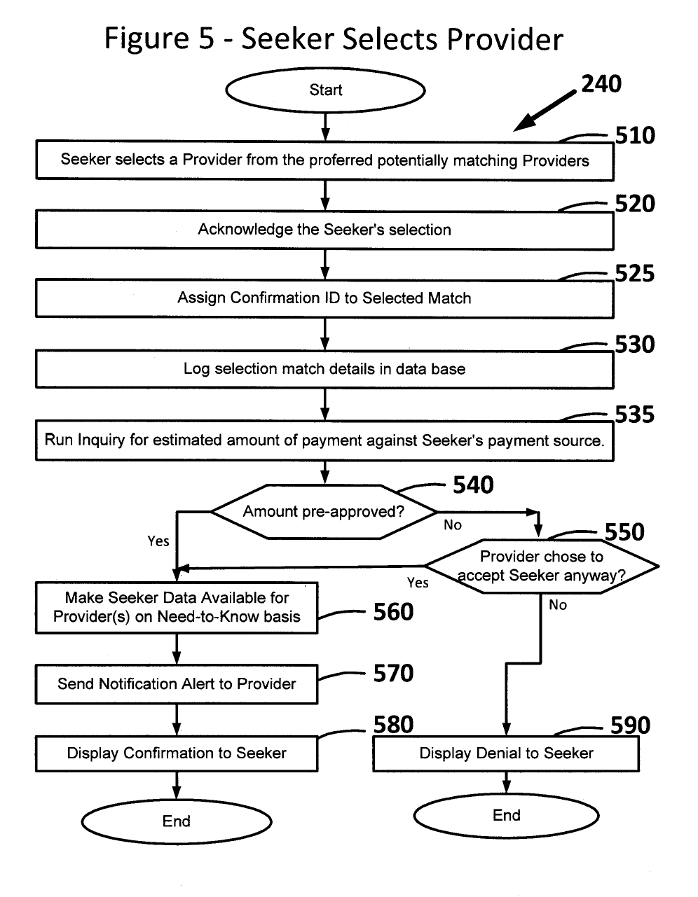

The response by the Fulfillment System 150 to the Seeker's selection of a URGS Provider may vary between embodiments, but also in some instances, within a given embodiment based on the Provider's Profile. FIG. 5 provides an example of one such embodiment.

A Seeker's selection of an URGS Provider—see 510—may be acknowledged by the Fulfillment System 150—reference 520—so the Seeker knows the Fulfillment System 150 has recorded the correct selection.

Referring to 525, a confirmation ID may be assigned that may be used subsequently to look up a record of the Seeker-Provider match that is stored in the Transaction Log—see 530.

In some embodiments, the Fulfillment System 150 may attempt—on behalf of the Provider—to pre-qualify the Seeker's ability to pay by running a test charge for a pre-set amount—typically a minimum payment—against the Seeker's payment card, insurance payer, or other payment source—see 535. Referencing 540, the Fulfillment System 150 may query the payment source for pre-approval.

In such embodiments, if the test charge is rejected by the payer, the Provider's Profile may be checked to see if the Provider accepts Seekers with potential payment problems—see 550. If not, the Fulfillment System 150 may inform the Seeker of denial—see 590—typically causing the Seeker to select a different potential Provider.

If on the other hand, the Seeker's payment source can pay, or the Provider accepts Seekers with potential payment problems, appropriate data about the Seeker—see 560—may be made available for the Provider and notification of the selection sent to the Provider—see 570—and a corresponding confirmation to the Seeker—see 580.

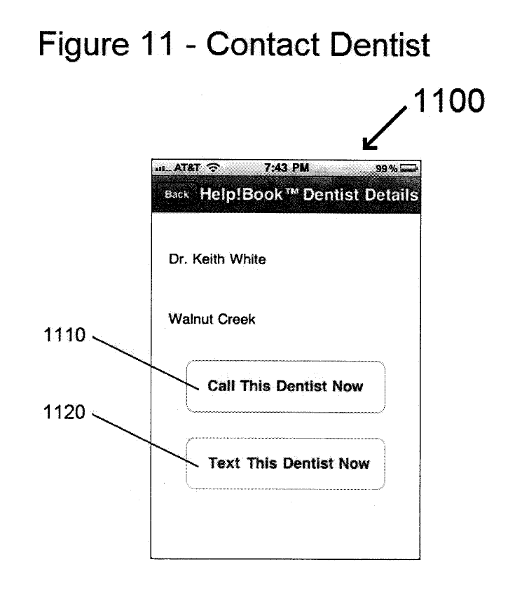

In some embodiments, the Fulfillment System 150 offers the Seeker the opportunity to initiate contact with the selected Provider immediately—FIG. 11. In other embodiments the Fulfillment System 150 may act on the Provider's behalf to arrange the details of providing the URGS to the Seeker.

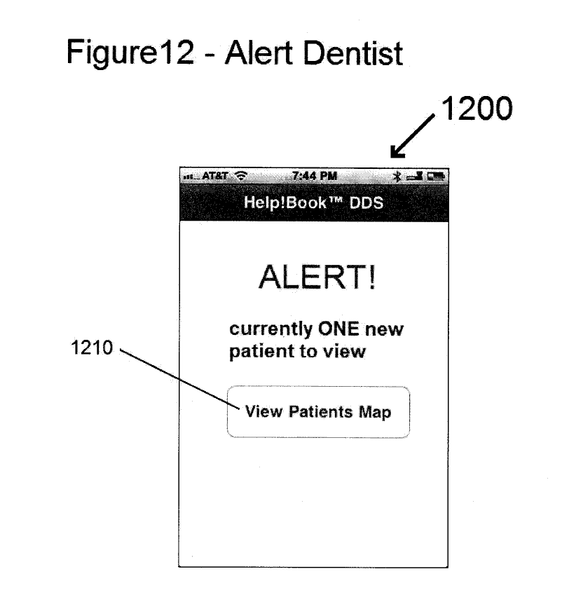

In most embodiments, particularly those where the Seeker contacts the Provider to complete the transaction, the Fulfillment System 150 acts to notify the Provider promptly of the selection—FIG. 12.

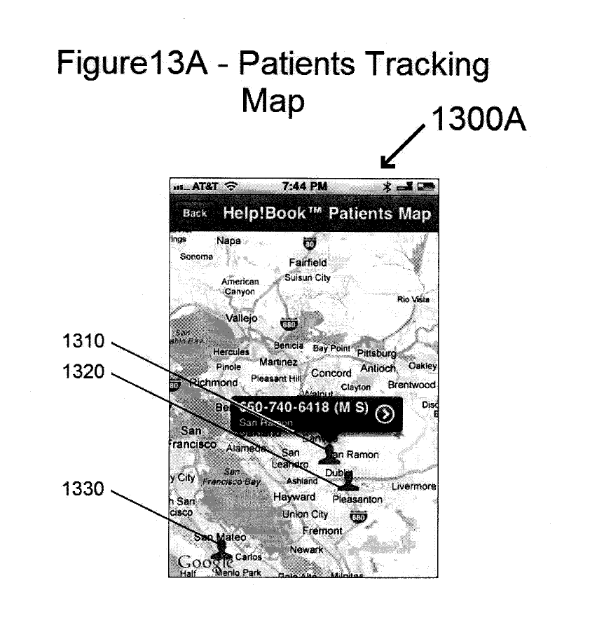

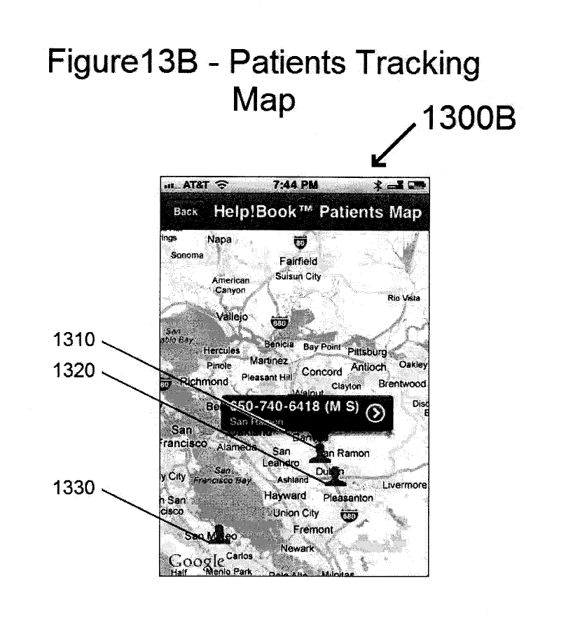

To assist both the Seeker and the Provider, the Fulfillment System 150 may provide a tracking service—see 260—and corresponding map-based display mechanism that periodically updates, substantially in real-time, the geo-location of the traveler(s)—be it the Seeker, the Provider, or both—relative to the rendezvous location where the Seeker and Provider intend to transact the acquisition of the URGS. In some embodiments, tracking maps are made available for both the Seeker—FIG. 10A, and the Provider—FIG. 13A.

In some instances, where the URGS are a good or goods, it may be the good(s) traveling and the tracking map reflecting the current Locale of the good(s). In some instances, the URGS may be provided by ways that are not well suited to tracking on a map, e.g., funds may be wired electronically with seeming instantaneous travel.

The Fulfillment System 150 may utilize an internal set of identifiers and transaction records in the process of matching Seekers to Providers for the purpose of acquiring URGS. In a typical embodiment, a stored set of records is retained in the Database 158 (“Transaction Log”) that records the details of each such process.

Operators of the Fulfillment System may derive revenue or other recompense—from Seekers and/or Providers and/or third parties—for use of the System 150 and/or use of information accumulated in the Database 158. Information stored in the Transaction Log may serve to determine what recompense is appropriate and from whom. It may be used for instance, to provide details that may appear in an invoice. Such details may for example include transaction information representing a “billable moment”—e.g., when a valued service—such as facilitating a Seeker to contact a Provider—instantiated and correspondingly recorded in the Transaction Log.

In addition to maintaining Transaction Logs, in some embodiments, the Fulfillment System 150 may maintain in its Database 158 algorithmic manipulations of various log data (“Metrics”) for a single User or several Users individually or a set of Users as an aggregate—where a given User may be a Provider, or a Seeker, or both a Provider and a Seeker (dual use of Fulfillment System 150). Such data may be measurements, statistics, and correlations for an individual Provider, or Providers as individuals, or Providers as an aggregate, and/or Multiple Providers.

In addition to maintaining Transaction Logs, and Metrics, in some embodiments the Fulfillment System 150 may keep stored copies (as permissible) or aggregations of any information—from or about Users or third parties—that enters the Fulfillment System 150. This information may at some time be manipulated to derive useful data that may be of value to operators of the Fulfillment System, Fulfillment System Users, or third parties.

For most Providers, a key goal of providing URGS is to be compensated. In many instances a Seeker may contemplate using the Provider again, and therefore want the Provider to be pleased with being compensated. Also—for both a Seeker and a Provider—having a record of having transacted the requisite compensation is useful in case of a dispute, or more in general, to maintain good credit histories.

The Fulfillment System 150 may facilitate the compensation of Providers—270. In some embodiments, the Fulfillment System 150 provides a basic service to the Provider—access to a reproduction of the Transaction Log record reflecting the pairing of the Provider and the Seeker.

In some embodiments, the Provider may enter additional information into the Transaction Log to record the status of the transaction with the Seeker and the status of the corresponding compensation by the Seeker. Such information may include third party confirmation of compensation of the Provider by the Seeker. In some instances, such information may be provided to the Fulfillment System 150 directly from authoritative third parties.

Some embodiments may provide broader facilitation to a Provider such as Appointments, Billing and Accounting.

In some embodiments, a Seeker has access to a record of Provider searches and pairings conducted by the Fulfillment System 150 on behalf of the Seeker. Furthermore, in some embodiments, a Seeker may have access to a record of other related transactions conducted by the Fulfillment System 150 on behalf of the Seeker.

Facilitating follow-up between Seekers and their Providers—see 280—is another utilization of the Transaction Log. For instance, the Fulfillment System 150 may communicate instructions from a selected Provider to the corresponding Seeker. In the opposite direction, the System 150 may communicate feedback from a Seeker to a Provider selected by that Seeker. Additionally, in some embodiments, the System 150 may obtain Provider ratings from Seekers and Seeker ratings from Providers and add these to User metrics in the Database 158. In some embodiments, positive or negative ratings may cause the System 150 to increase or decrease a given Provider's ranking, which may in turn impact the frequency of that Provider being proffered.

Follow-up with Seekers may be a key component of a Provider's client loyalty program. In some instances, it may generate immediate follow-on transactions. In other instances, it may generate good-will. By facilitating follow-ups, the Fulfillment System 150 may gain access to the Seeker's opinions, and help increase the Seeker's loyalty to the Provider. A side benefit may be increased loyalty of both the Seeker and the Provider to the Fulfillment System 150.

In addition to direct follow-up, the System 150, may provide, support, be affiliated with, link to, direct Users to, or otherwise facilitate follow-up via user forums/social media. Many consumers use social media such as Yelp, Facebook and Twitter to express their praise and/or criticisms regarding a vendor.

The Fulfillment System 150 facilitates Loyaltization—i.e., creating, maintaining, promoting and expanding User loyalty to the Fulfillment System 150—focused on both Providers and Seekers—see 290. Loyaltization may play an important role in the commercial acceptance and success of the Fulfillment System 150.

Loyalty may be created as a byproduct of the inherent usefulness of the Fulfillment System 150, but in some embodiments loyalty may be actively sought—using additional features and incentives—to make Providers and Seekers want to recommend the Fulfillment System 150 to others and continue using it themselves. For example, the System 150 may increase the ranking of a valued Provider and thereby increase the likelihood and frequency of that Provider being proffered. Additionally, in some embodiments, the System 150 may improve other metrics associated with a valued Seeker or Provider. Such metrics might be shared for instance with other Users and/or third parties.

In some embodiments, the Fulfillment System 150 may administer loyalty programs on the behalf of individual Providers. Additionally, the Fulfillment System 150 may operate loyalty programs on behalf of an aggregate of multiple Providers and offer incentives to Seekers based on desired behavior relative to any Provider within said aggregation. Such loyalty programs conducted on behalf of Providers also have the benefit of Loyaltization of Providers to the Fulfillment System 150. Similarly, in some embodiments, the System 150 may administer loyalty programs—on behalf of individual Seekers or Seekers in aggregate—that reward Providers and increase good-will between Providers and Seekers and perhaps the System 150 as well. Loyalty programs, whether on behalf of Seekers or Providers, may award benefits to Users—for example discounts for future URGS acquired using the System 150 or rewards such as goods and/or services from Providers and/or third parties. For instance, rewards may include airline frequent flier miles or hotel stay points. Also, in some embodiments, the System 150 may offer enrollment in third party loyalty programs

In many urgent situations, a Seeker may have need for more than one URGS. For example, a vacationer with a broken down car may need a place to stay overnight in addition to automotive repair. If the car is seriously damaged, a rental vehicle may be needed. In typical embodiments, the Fulfillment System 150 may proactively facilitate the proffering of a set of related URGS based on Seeker-provided information and/or inference by the System 150. In some embodiments, the System 150 may facilitate the proffering of non-urgent services and goods that might be useful in the context of the Seeker's circumstances. For instance, the stranded traveler might like a book or newspaper to read or perhaps some comfort food—once the car and a place to stay have been taken care of A Seeker's Profile may determine whether and how the System 150 proffers, suggests or recommends additional services and goods.

In addition to directly facilitating the Seeker's acquisition of a set of circumstance-related URGS and non-urgent services and goods—in some embodiments—the Fulfillment System 150, may suggest, recommend or otherwise prompt a Provider to proffer additional URGS and other non-urgent services and goods to a Seeker.

### II. Exemplary Scenarios

The following discussions and references to figures are provided to illustrate a set of exemplary scenarios for some embodiments of the Fulfillment System 150. The examples may include particular limitations which are unique to the given example and are not intended to extend to the invention as a whole. Likewise, some examples may have been simplified in order to aid in clarity. It is understood that while the foregoing examples aid in explanation and clarification of the present invention, these examples do not limit the scope or function of the present invention.

In some instances, graphic representations with the appearance of screenshots from mobile communication devices are provided by way of example to aid in the illustration of some embodiments. This is not intended to imply that mobile communication devices are preferred to the exclusion of other terminal device types.

Several different fulfillment scenarios may occur when a Seeker and Provider are not situated at the same place. Such scenarios include, but are not necessarily limited to:

A. The Seeker travels to a rendezvous location that is the Provider's Locale,

B. The Provider travels to a rendezvous location that is the Seeker's Locale,

C. The Seeker and the Provider both travel to a fixed rendezvous location.

D. The Seeker and the Provider both travel towards each other without a fixed rendezvous location until they converge.

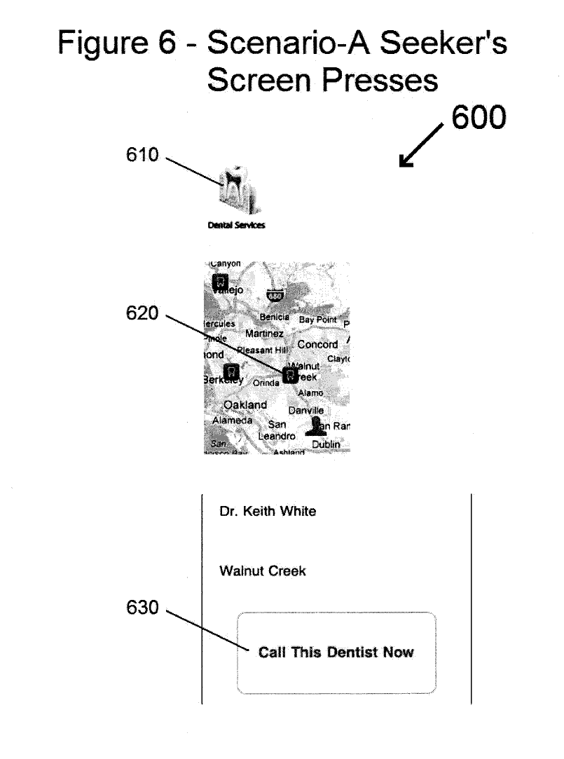

The scenario descriptions that follow detail the individual Scenarios—A, B, C and D—by stepping through the logic flow diagrams—FIGS. 2, 3, 4 and 5—and by providing corresponding exemplary screen shots to illustrate the User experience. FIGS. 6, 7 and 8—corresponding to Scenarios A, B and C, respectively—illustrate the process of selecting and contacting a Provider from the Seeker's perspective. In each instance, the Seeker actuates a virtual button on each of a sequence of three screens: button actuation 1—Select URGS; button actuation 2—Select a Provider; and button actuation 3—Contact that Provider.

### Scenario A—Seeker Travels to Provider's Locale

To illustrate the scenario of a Seeker traveling to the Provider's Locale, the Seeker is imagined to be a business traveler from Spain—Mirabella Sanchez—who has a severe toothache; the URGS is urgent dental care; and the URGS Providers are dentists. Referring back to FIG. 6, it is possible for the Seeker to use a small number of virtual button actuations to: 1) select URGS Services (dental)—610; 2) select a Provider (dentist)—620; and 3) contact that Provider (dentist)—630.

Referring to FIG. 2 step 230, the Fulfillment System 150 works to proffer Providers of the type sought by the Seeker. FIG. 3 details an embodiment of step 230. In step 310, the Fulfillment System 150 determines from the Seeker the type of URGS sought—in this example: urgent dental care.

In step 320, the Fulfillment System 150 determines the Seeker's Locale. In this example, the Seeker is imagined to use a “smart phone” mobile communication device, which allows the Fulfillment System 150 to use GPS to geo-locate the Seeker, who at the time is in San Ramon, Calif.

Referencing step 330, the Fulfillment System 150 examines its Database 158 and determines that the corresponding type of Provider sought is: a dentist. In this example, the Fulfillment System 150 uses the dentist office location specified in each Provider's Profile in the Database 158 as that Provider's Locale. Each Provider's Locale, so determined, is compared to the Seeker's Locale—San Ramon in this example—to determine if a given Provider is proximate. A set of proximate Providers is accumulated in this fashion by the Fulfillment System 150. In this example, the Fulfillment System 150 examines the Database 158 for dentists and identifies eight Providers proximate to San Ramon.

In Step 340, the Fulfillment System 150 further vets the potential Providers. FIG. 4 details an embodiment of the vetting process. In Step 430 each of the potential Providers is vetted based on a comparison of preferences—preset by the Seeker in the Seeker's Profile in the Database 158—against a Provider's characteristics found in the Provider's Profile. Mirabella's Seeker Profile in the Database 158 indicates that she requires a Spanish-speaking Provider. Three of the potential Providers are rejected by the Fulfillment System 150 because their Profiles in the Database 158 do not have Spanish selected as one of the languages they speak.

In Step 460, for each potential Provider, the Provider is vetted based on the Provider's willingness to accept the Seeker based in turn on a comparison of preferences—preset by the Provider in the Provider's Profile in the Database 158—against the Seeker's characteristics found in the Seeker's Profile in the Database 158. Two potential Providers have indicated preferences for payment specifically in cash or by pre-approved insurance organization. Mirabella's Seeker Profile indicates that she desires to pay either with V-Pay debit card or by check. Mirabella's Spanish dental insurance does not match the pre-approved insurance payers in these two Provider's Profiles. Therefore, these additional two potential Providers are rejected by the Fulfillment System 150. Three other Providers do accept checks and therefore pass the vetting process.

Referring to step 350, the Fulfillment System 150 has three potential Providers to display to Mirabella, so she can select one from them. One Provider has an office in Berkeley, one has an office in Vallejo, and the third has an office in Walnut Creek. FIG. 10A provides an example of what the display may look like on Mirabella's mobile communication device. Shown there are four icons. The human head and shoulders silhouette icon 1050 represents Mirabella's Locale in San Ramon. The three tooth outline icons represent the three potential URGS Providers—the dentists in Vallejo 1010, Walnut Creek 1020, and Berkeley 1030, respectively.

Referring to FIG. 2 step 240, the Seeker selects an URGS Provider from the three potential Providers proffered by the Fulfillment System 150. In this example, the Seeker Mirabella selects the Provider in Walnut Creek by tapping on the icon 1020 in FIG. 10A. In this example, the Provider—Dr. Keith White—has preset his preferences in his Provider Profile in the Database 158 such that the Fulfillment System 150 prompts the Seeker—Mirabella—to contact Dr. White, as shown in FIG. 11, by the actuating virtual button 1110 to phone or the virtual button 1120 to text directly from her mobile communication device. At the same time, the Fulfillment System 150, sends Dr. White a notice to his mobile communication device—see FIG. 12-alerting him to expect to be contacted by a Seeker—Mirabella Sanchez.

The Fulfillment System 150 can facilitate communication between Seeker and Provider, by either providing contact information for the Provider or—as in this example—providing a facility to contact the Provider directly. In this instance, Mirabella telephones Dr. White by actuating the virtual button 1110 which causes her mobile communication device to place the phone call directly. The Fulfillment System 150 is not a party in the conversation between the Seeker Mirabella and the URGS Provider Dr. White, DDS.

Referring to FIG. 12, the Provider—having been alerted to expect to be contacted by a new Seeker—can view the Locale of the new Seeker by actuating the virtual button 1210, which Dr. White does. In this example, the Fulfillment System 150 responds by displaying FIG. 13A, a tracking map on which Provider Dr. White can look to see what information the Fulfillment System 150 has on the geo-location of any URGS Seekers who may be coming to his Locale. The tracking map includes a new icon—1310—representing the Locale of the new Seeker, Mirabella Sanchez, that the Fulfillment System 150 determines to be in San Ramon.

Dr. White's mobile communication device rings with the call from Mirabella—Dr. White answers. They discuss Mirabella's tooth and her dental history; go over compensation and any final details necessary to decide whether to meet; and agreeing to do so, set up an appointment for Mirabella.

In step 260, the Fulfillment System 150 initiates ongoing tracking of the progress of the Seeker traveling to meet the Provider. Referring to FIG. 13B, the Fulfillment System 150 periodically updates the a tracking map—as it may appear on Provider Dr. White's mobile communication device—to reflect changes in the Locale of Seekers traveling to the Provider's Locale. In the example, Mirabella's icon 1310 has not moved, because Mirabella needs to arrange transport to travel to Dr. White's Locale. Meanwhile, icon 1320 and icon 1330—representing two other Seekers traveling to Provider Dr. White's Locale—have both moved.

In step 270, the Fulfillment System 150 facilitates compensation by logging the transaction that has just occurred whereby Seeker Mirabella Sanchez selected Provider Dr. White. Both Dr. White and Mirabella Sanchez can subsequently look up the Transaction Log record.

Referring to step 280—in this example, Dr. White's Provider Profile in the Database 158 is preset for the Fulfillment System 150 to facilitate follow-ups by alerting Dr. White at a future time to follow-up with a Seeker who has selected him—in this instance with Mirabella Sanchez.

The Fulfillment System 150 facilitates Loyaltization—step 290—as described above.

### Scenario B—Provider Travels to Seeker's Locale

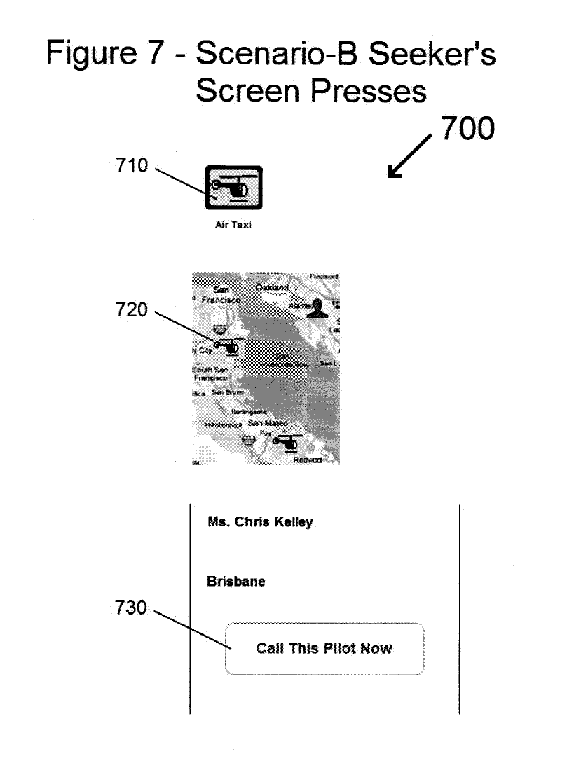

To illustrate the scenario of a Provider traveling to the Seeker's Locale, the Seeker is imagined to be a high-powered corporate executive just arrived at a major airport and running late for a critically important business meeting—Lee Nelson; the URGS is transportation to meeting location in time for his presentation; and the URGS Providers are helicopter operators. Referring back to FIG. 7, it is possible for the Seeker to use a small number of virtual button actuations to: 1) select URGS Service (helicopter)—710; 2) select a Provider (helicopter operator)—720; and 3) contact that Provider (helicopter operator)—730.

Referring to step 230—the Fulfillment System 150 works to proffer Providers of the type sought by the Seeker.

Referring to FIG. 3 step 310, the Fulfillment System 150 determines from the Seeker the type of URGS sought—in this example: urgent helicopter commuter service.

In step 320, the Fulfillment System 150 determines the Seeker's Locale. In this example, the Seeker's Locale is determined by the System 150 via GPS support in his “smart phone” to be Alameda, Calif.

In Step 330, the Fulfillment System 150 examines its Database 158 and determines that the corresponding type of Provider sought is: a helicopter operator. In this example, the Fulfillment System 150 uses the Provider's heliport location specified in each Provider's Profile in the Database 158 as that Provider's Locale. Each Provider's Locale, so determined, is compared to the Seeker's Locale—Alameda—to determine if a given Provider is proximate. A set of proximate Providers is accumulated in this fashion by the Fulfillment System 150. The System 150 examines the Database 158 for helicopter operators and identifies four Providers proximate to Alameda.

Referring to step 340, the Fulfillment System 150 further vets the potential Providers. FIG. 4 shows step 340 in greater detail. Referring to step 430, each of the potential Providers is vetted based on a comparison of preferences—preset by the Seeker in the Seeker's Profile in the Database 158—against a Provider's characteristics found in the Provider's Profile. One helicopter operator is found to be currently unavailable and is vetted accordingly. This leaves three potential Providers.

In step 460, for each potential Provider, the Provider is vetted based on the Provider's willingness to accept the Seeker. Such willingness is determined by a comparison of preferences—preset by the Provider in the Provider's Profile in the Database 158—against the Seeker's characteristics found in the Seeker's Profile in the Database 158. Lee has sterling credit and five major credit cards. He is acceptable to all of the Providers.

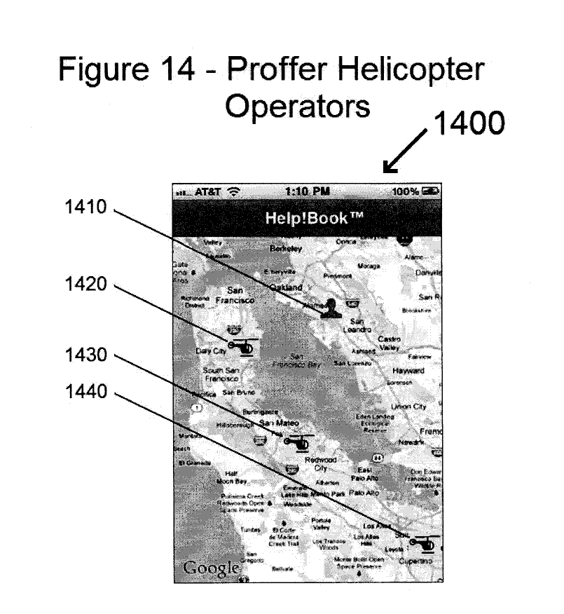

Referring to FIG. 3 step 350—the Fulfillment System 150 has three potential Providers to display to Lee, so he can select one from them—one in Brisbane, the second in San Carlos, and the third in Santa Clara. FIG. 14 provides an example of what the display may look like on Seeker Lee Nelson's mobile communication device. Shown there are four icons. The human head and shoulders silhouette icon 1410 represents Lee's Locale in Alameda. The three helicopter outline icons represent the three potential URGS Providers—the helicopter operators in Brisbane 1420, San Carlos 1430, and Santa Clara 1440, respectively.

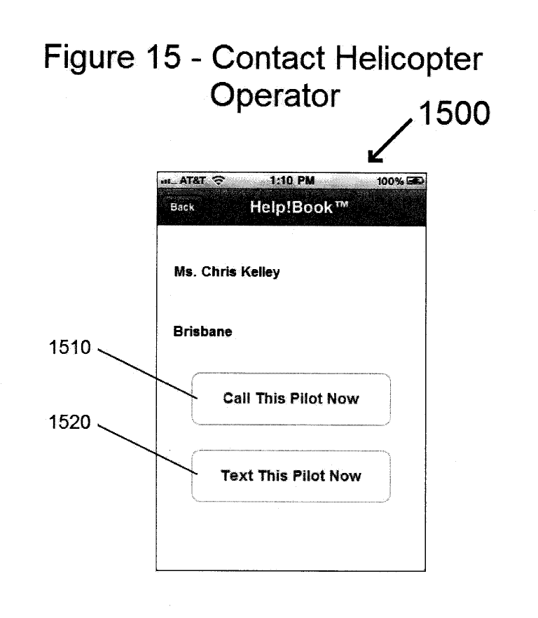

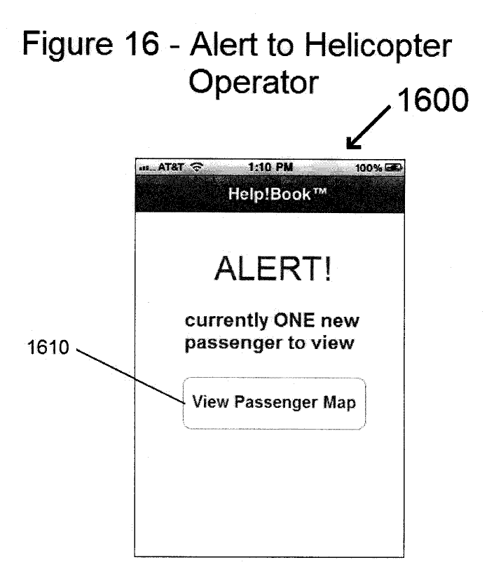

In FIG. 2 step 240, the Seeker selects an URGS Provider from the three potential Providers proffered by the Fulfillment System 150. In this example, the Seeker Lee selects the closest Provider—based in Brisbane—by actuating the virtual button represented by the icon 1420 in FIG. 14. In this instance, the Helicopter operator—Chris Kelley—has preset her preferences in her Provider Profile in the Database 158 such that the System 150 prompts the Seeker—Lee—to contact Ms. Kelley, as shown in FIG. 15, by the actuating the virtual button 1510 to phone or the virtual button 1520 to text directly from his mobile communication device. At the same time, the Fulfillment System 150 sends Ms. Kelley a notice to her mobile communication device—see FIG. 16—alerting her to expect to be contacted by a Seeker—Lee Nelson.

The Fulfillment System 150 can facilitate communication between Seeker and Provider, by either providing contact information for the Provider or—as in this example—providing a facility to contact the Provider directly. In this instance, Lee telephones Ms. Kelley by actuating the virtual button 1510 which causes his mobile communication device to place the phone call directly. The Fulfillment System 150 is not a party in the conversation between the Seeker Mr. Lee Nelson and the URGS Provider Ms. Chris Kelley—helicopter operator.

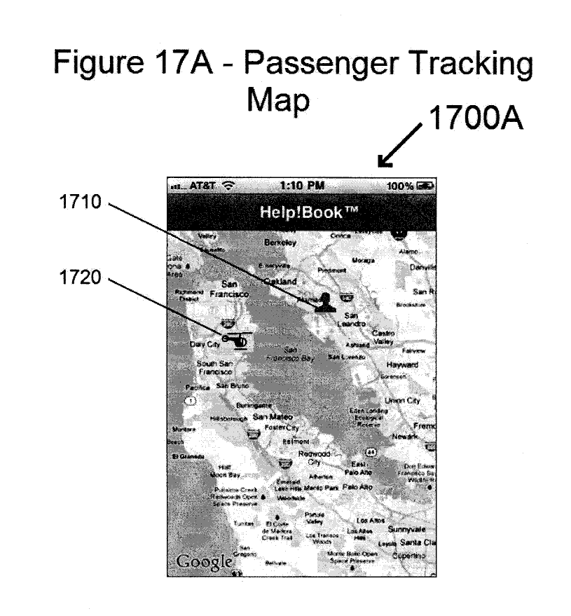

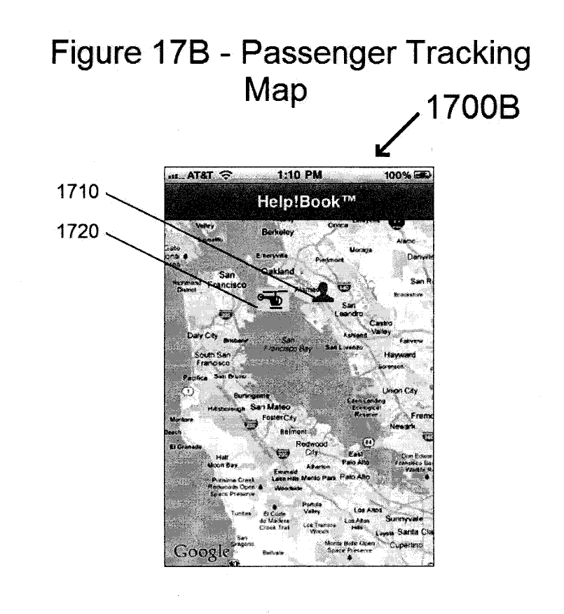

Referring to FIG. 16, the Provider—having been alerted to expect to be contacted by a new Seeker—can view the Locale of the new Seeker by actuating the virtual button 1610, which Ms. Kelley does. In this example, the Fulfillment System 150 responds by displaying FIG. 17A, which Provider Ms. Kelley can examine to see geo-location information the System 150 has on URGS Seekers she may intend to travel to—in this instance, only Mr. Nelson. The tracking map includes a single head and shoulders silhouette icon—1710—representing the new Seeker—Lee Nelson—whose Locale the Fulfillment System 150 displays in Alameda.

Ms. Kelley's mobile communication device rings with the call from Lee Nelson—Ms. Kelley answers. They discuss Lee's urgent need for an immediate helicopter ride to Palo Alto; go over compensation and any final details necessary to be certain that Mr. Nelson is at the correct location at the airport in Alameda; and agreeing to the fare, set up to meet at Lee Nelson's Locale in Alameda.

In step 260, the Fulfillment System 150 starts ongoing tracking of the Provider as the Seeker awaits the Provider's arrival. Referring to FIG. 17B, the Fulfillment System 150 periodically updates a tracking map—as it may appear on Provider Chris Kelley's mobile communication device—to reflect changes in the Locale of the Seeker and/or Provider. In the example, Lee Nelson's icon 1710 has not moved, but Ms. Kelley's icon 1720 is now substantially closer to Seeker Lee Nelson's Locale in Alameda.

In step 270, the Fulfillment System 150 facilitates compensation by logging the transaction that has just occurred whereby Seeker Lee Nelson selected Provider Ms. Kelley—the helicopter operator. Both Ms. Kelley and Lee Nelson may subsequently look up the Transaction Log record.

Referring to step 280—in this example, Ms. Kelley's Provider Profile in the Database 158 is not preset for the Fulfillment System 150 to facilitate follow-ups. However because the Transaction Log record is available to Ms. Kelley, she can follow-up with Lee Nelson if she chooses to do so. In this case she does follow up promptly—step 280—because she would like referrals and hopefully a repeat customer. She subsequently revises her Provider Profile to facilitate follow-ups.

The Fulfillment System 150 facilitates Loyaltization—step 290—as described above.

### Scenario C—the Seeker and the Provider Both Travel to a Rendezvous Location.

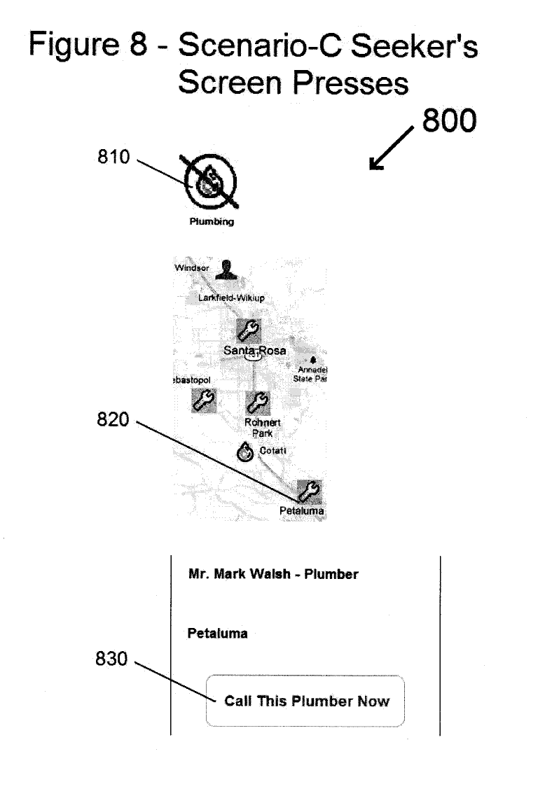

To illustrate the scenario of a Seeker and a Provider both traveling to a rendezvous location, the Seeker is imagined to be a landlord—Rick Sawyer—who has a leaking pipe at a rental home; the URGS is urgent plumbing repair; and the URGS Providers are plumbers. Referring back to FIG. 8, it is possible for the Seeker to use a small number of virtual button actuations to: 1) select URGS (plumbing services)—810; 2) select a Provider (plumber)—820; and 3) contact that Provider (plumber)—830.

FIG. 2, step 230, the Fulfillment System 150 works to proffer Providers of the type the Seeker requires. FIG. 3 details an embodiment of step 230.

Referring to FIG. 3, step 310, the Fulfillment System 150 determines from the Seeker the type of URGS sought—in this example: urgent plumbing.

Referring to step 320, the Fulfillment System 150 determines the Seeker's Locale. In this example, the Seeker is not at the location where the URGS need to be provided—i.e., the rental home with the leaking pipe. Rick Sawyer, the Seeker, enters the address of the rental home—located in Cotati, Calif.—into the Fulfillment System 150. The Fulfillment System 150 processes the address to derive a geo-location and puts both the address and the corresponding geo-location into the Database 158 to set the rendezvous location.

At Step 330, the Fulfillment System 150 examines its Database 158 and determines that the corresponding type of Provider sought is: a plumber. In this example, the System 150 uses the plumber business location specified in each Provider's Profile in the Database 158 as that Provider's Locale. Each Provider's Locale is compared to the rendezvous location—Cotati—to determine if a given Provider is proximate. A set of proximate Providers is figured accordingly by the Fulfillment System 150. Processing plumbers in the Database 158, the System 150 identifies ten Providers proximate to Cotati.

Referring to Step 340, the Fulfillment System 150 further vets the potential Providers. FIG. 4 details an embodiment of the vetting process.

In Step 430, each of the potential Providers is vetted based on a comparison of preferences set by the Seeker in the Seeker's Profile in the Database 158—against a Provider's characteristics set in the Provider's Profile. Rick Sawyer's Seeker Profile indicates that he requires a English-speaking Provider. The Fulfillment System 150 rejects one of the potential Providers because their Profile in the Database 158 does not include English as one of the languages spoken by that plumber. Rick also requires licensed and bonded contractors—all potential Providers comply. Additionally, Rick's Seeker Profile contains a preference for a work guarantee. Two of the potential Providers do not have “work guaranteed” selected in their Profiles, and as a result are rejected by the System 150.

In Step 460, for each potential Provider, the Provider is vetted based on the Provider's willingness to accept the Seeker. That willingness is determined based on a comparison of preferences—the Provider's preferences expressed in the Provider's Profile in the Database 158—against the Seeker's characteristics preset in the Seeker's Profile in the Database. Three potential Providers have indicated preferences for payment specifically in cash. Rick's Seeker Profile reflects his preference to pay by check or credit card—but not cash. Therefore, the Fulfillment System 150 rejects these three additional potential Providers. Four remaining Providers accept check or credit payment—so they pass the vetting process.

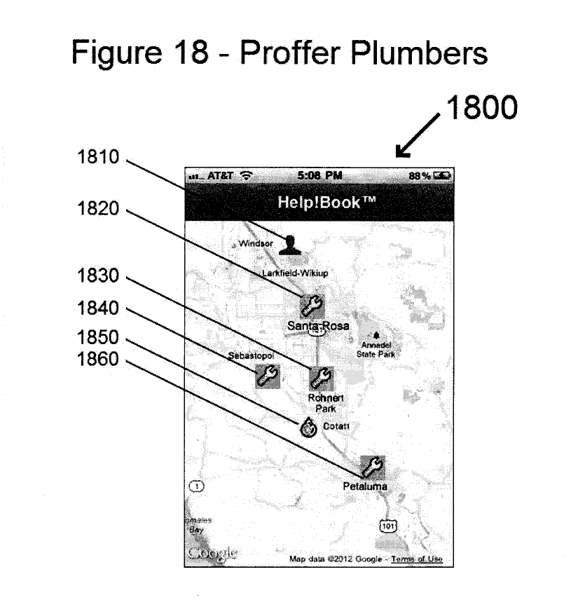

Referring to FIG. 3, step 350, the Fulfillment System 150 has four potential Providers to display to Rick, to allow him to select one of them. One Provider has an office in Sebastopol, the second is based in Santa Rosa, the third works from Rohnert Park, and the fourth has a storefront in Petaluma. FIG. 18 shows a display of proffered Providers as it may appear on Rick's mobile communication device. There are six icons shown. The human head and shoulders silhouette icon 1810 represents Seeker Rick Sawyer's Locale—currently at work in Windsor, where he received the distressed call from his tenant. The four wrench-outline icons represent the potential URGS Providers—the plumbers—in Santa Rosa 1820, Sebastopol 1840, Rohnert Park 1830, and Petaluma 1860. The water drop icon 1850 denotes the rendezvous location in Cotati where the leak is.

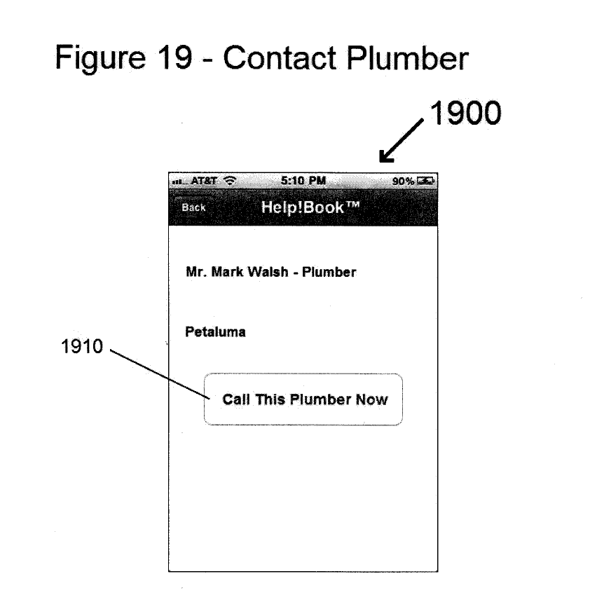

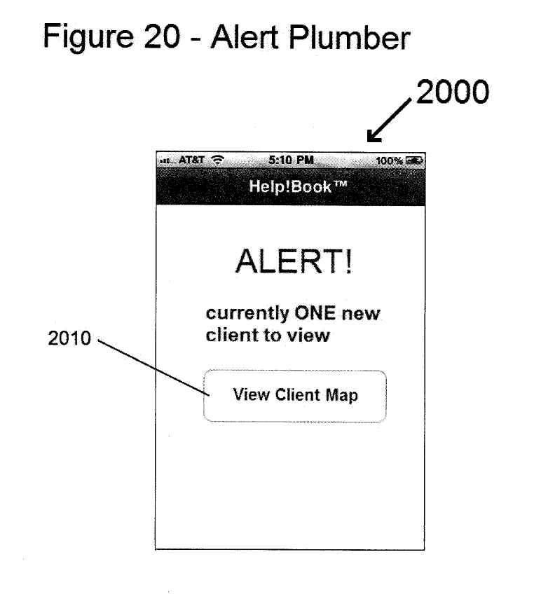

In FIG. 2, at step 240, the Seeker selects a Provider from the four choices proffered by the Fulfillment System 150 in this example. Rick selects the Provider in Petaluma by tapping on the icon 1860 in FIG. 18. The Provider (plumber) in this example—Mark Walsh—has set up his preferences in his Provider's Profile in the Database 158 so that the System 150 prompts the Seeker—Rick—to contact Mark, as shown in FIG. 19. Actuating the virtual button 1910 telephones from Rick's mobile communication device to Mark's. Mark's Provider Profile does not indicate an address for texting, so that option is not offered to Rick. The Fulfillment System 150, sends the Provider Mark a notice to his mobile communication device—see FIG. 20-alerting him to expect to be contacted by a Seeker—Rick Sawyer.

The Fulfillment System 150 can facilitate communication between Seeker and Provider, by either providing contact information for the Provider or—as in this example—providing a facility to contact the Provider directly. In this instance, Rick telephones Mark by actuating the virtual button 1910 which causes his mobile communication device to place the phone call directly. The Fulfillment System 150 is not a party in the conversation between the Seeker Rick and the URGS Provider Mark Walsh.

Referring to FIG. 20, the Provider—having been alerted to expect to be contacted by a new Seeker—can view the Locale of the new Seeker by actuating the virtual button 2010, which Mark Walsh chooses not to do. Instead, he waits for the Seeker to phone. Mark's mobile communication device rings with the call from Rick Sawyer—Mark answers. They discuss the leaking pipe problem and also other work Rick would like done. They discuss Mark's availability, how he guarantees his work, and what his labor rate is. They agree to the work, and arrange to rendezvous at the rental home in Cotati.

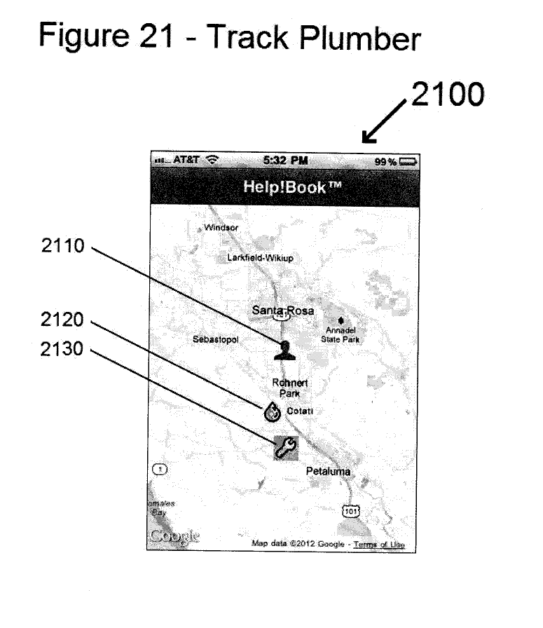

In step 260, the Fulfillment System 150 starts ongoing tracking of the progress of the Provider and/or the Seeker both traveling to meet at the rendezvous location. Referring to FIG. 21, the Fulfillment System 150 periodically updates a tracking map—as it may appear on Seeker Rick Sawyer's mobile communication device—displaying the updated Locales of both the Seeker and Provider.

Referring to step 270, the Fulfillment System 150 facilitates compensation by logging the transaction whereby Seeker Rick Sawyer selected Provider Mark Walsh. Both Seeker and Provider can subsequently look up the Transaction Log record. Each can separately associate additional annotation with the Transaction Log. The Seeker and Provider annotations are separate and private to Seeker and Provider, respectively. They have no indication of, or access to, each other's annotations. In this example, Rick makes notes on the verbal guarantee he received from the Provider Mark. Separately, Mark records the details of the work done including time and materials and the amount charged to the Seeker's credit card.

In step 280, the Fulfillment System 150 facilitates follow-up. Mark's Provider Profile in the Database 158 indicates that the Fulfillment System 150 may, at a set number of days subsequent to a given transaction, prompt him to follow-up with the Seeker—in this case Rick Sawyer. The corresponding annotated Transaction Log reminds him of details of his work for the Seeker that are useful in conducting the follow-up. Mark may add further annotation to the Transaction Log to record the results of a given follow-up.

The Fulfillment System 150 facilitates Loyaltization—step 290. Mark has handled a large number of Seeker's URGS requests and has gotten consistently high ratings for quality and promptness. Accordingly, the Fulfillment System 150 improves the weighting in Mark's Provider Profile so as to increase his ranking and therefore likelihood of selection in the future. In some embodiments, the System 150 notifies the Provider of such improvement in weighting/ranking

Scenario D—Seeker and Provider's Both Travel Until they Converge

To illustrate the scenario of a Seeker and a Provider both traveling towards each other—without a fixed rendezvous location—until they converge, the Seeker is imagined to be a baseball fan—Judy Piper—who has arrived at the stadium with her son Bobby on his birthday, but has tickets for the wrong day; the URGS are two tickets for today's baseball game; and the URGS Providers are same-day ticket sellers.

FIG. 2, step 230, the Fulfillment System 150 works to proffer Providers of the type the Seeker requires. FIG. 3 details an embodiment of step 230.

Referring to FIG. 3, step 310, the Fulfillment System 150 determines from the Seeker the type of URGS sought—in this example: two same-day baseball tickets.

Referring to step 320, the Fulfillment System 150 determines the Seeker's Locale. In this example, the Seeker is in the North parking lot of the baseball stadium as geo-located by her “smart phone.”

At Step 330, the Fulfillment System 150 examines its Database 158 and determines that the corresponding type of Provider sought is: a same-day ticket seller. In this example, the Fulfillment System 150 uses the geo-location determined from a given Provider's “smart phone” to determine that Provider's Locale.

Each Provider's Locale is compared to the Seeker's Locale to determine if a given Provider is proximate. A set of proximate Providers is figured accordingly by the Fulfillment System 150. Processing same-day ticket sellers in the Database 158, the System 150 identifies twelve Providers proximate to Judy's Locale at the baseball stadium.

Referring to Step 340, the Fulfillment System 150 further vets the potential Providers. FIG. 4 details an embodiment of the vetting process.

In Step 430, each of the potential Providers is vetted based on a comparison of preferences set by the Seeker in the Seeker's Profile in the Database 158—against a Provider's characteristics set in the Provider's Profile. Judy Piper's Seeker Profile indicates that she requires a positive proof of identification. Six of the potential Providers do not have “will prove identity” selected in their Profiles, and as a result are rejected by the Fulfillment System 150.

In Step 460, for each potential Provider, the Provider is vetted by the Fulfillment System 150 based on the Provider's willingness to accept the Seeker. That willingness is determined based on a comparison of preferences—the Provider's preferences expressed in the Provider's Profile in the Database 158—against the Seeker's characteristics preset in the Seeker's Profile in the Database 158. Four potential Providers have indicated preferences for payment specifically in either cash or by credit card. Judy's Seeker Profile reflects her need to pay by check—not credit card nor cash. Judy assumes she isn't carrying sufficient cash and is not about to give out her credit card info to a stranger in a stadium parking lot. The System 150 rejects these four additional potential Providers. Two remaining Providers accept checks—so they pass the vetting process.

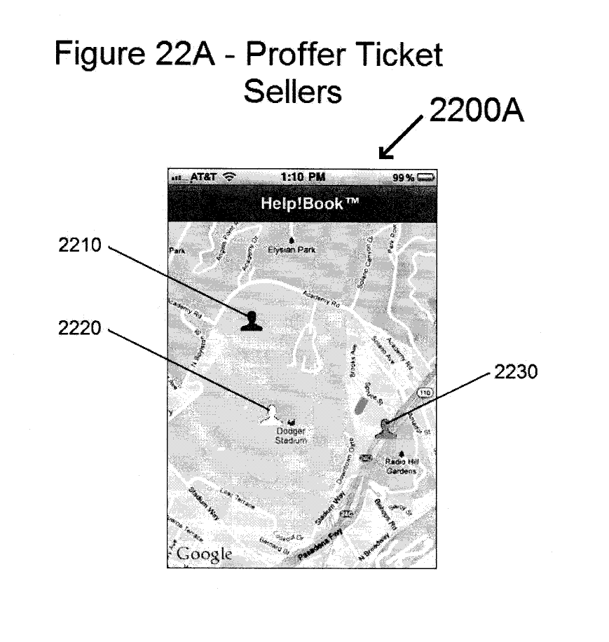

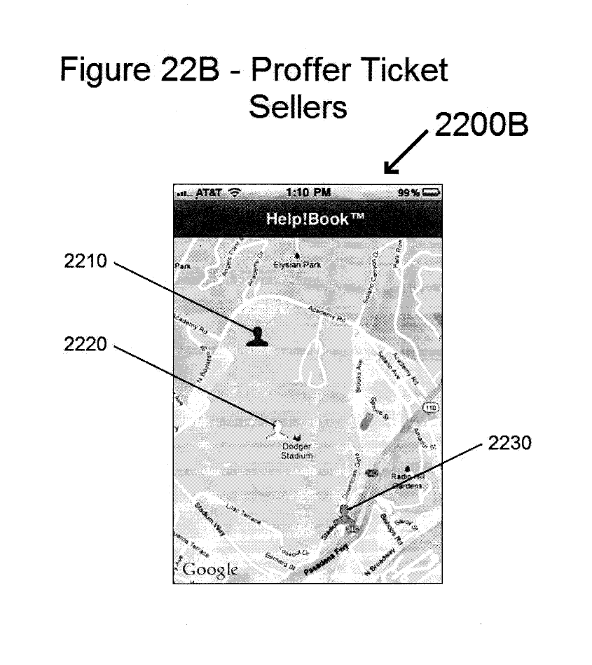

Referring to FIG. 3, step 350, the Fulfillment System 150 has two potential Providers to display to Judy, to allow her to select one of them. One Provider is in the West parking lot of the baseball stadium. The other Provider is caught in traffic a few blocks from the stadium. FIG. 22A shows a display of proffered Providers as it may appear on Judy's mobile communication device. There are three icons shown. The blue human head and shoulders silhouette icon 2210 represents Judy's Locale in the North parking lot. The yellow human head and shoulders silhouette icon 2220 represents the Locale of the Provider in the West parking lot. The violet human head and shoulders silhouette icon 2230 represents the Locale of the other Provider—still approaching the stadium.

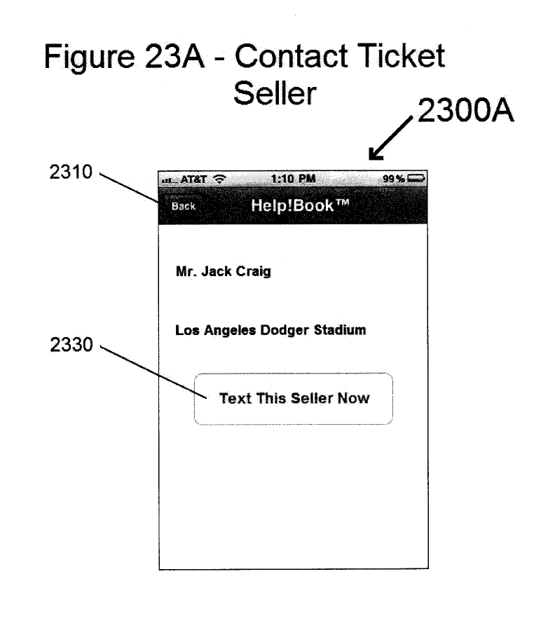

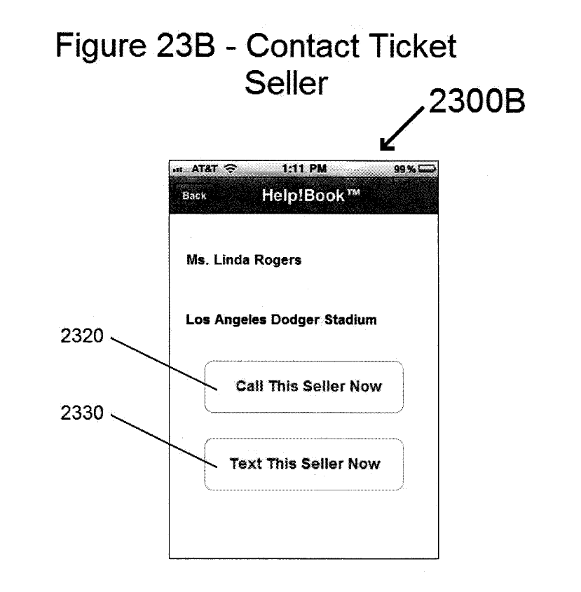

In FIG. 2, at step 240, the Seeker selects a Provider proffered by the Fulfillment System 150—one of two choices in this example. Judy selects the “yellow” ticket seller by tapping on the icon 2220 in FIG. 22A. The Provider in this example—Jack Craig—has set up his preferences in his Provider's Profile in the Database 158 so that the Fulfillment System 150 prompts the Seeker—Judy—to contact Jack, as shown in FIG. 23A. Jack's Provider Profile does not indicate a phone number—only an address for texting. Judy's Profile could—but does not—indicate “no texting”.

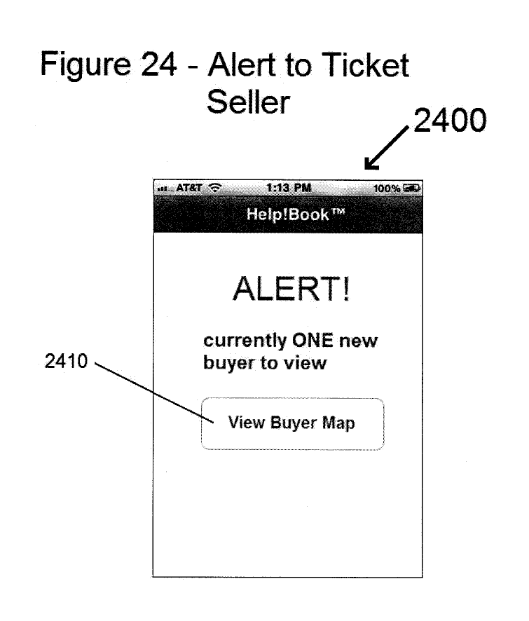

When Judy sees that Jack can not be phoned, she immediately actuates the “back” virtual button 2310 that returns her to an updated Provider proffer display—FIG. 22B—where she taps the violet icon 2230. The fall back Provider in this example—Linda Rogers—has set up her preferences in her Provider's Profile in the Database 158 so that the Fulfillment System 150 prompts the Seeker—Judy—to contact Linda, as shown in FIG. 23B. Linda's Provider Profile provides both a phone number and a texting address. The System 150 sends Linda the ticket seller a notice to her mobile communication device—see FIG. 24-alerting her to expect to be contacted by a Seeker—Judy Piper.

The Fulfillment System 150 can facilitate communication between Seeker and Provider, by either providing contact information for the Provider or—as in this example—providing a facility to contact the Provider directly. In this instance, Judy telephones Linda by actuating virtual button 2320 which causes her mobile communication device to place the phone call directly. The Fulfillment System 150 is not a party in the conversation between the Seeker Judy and the URGS Ticket Seller Linda Rogers.

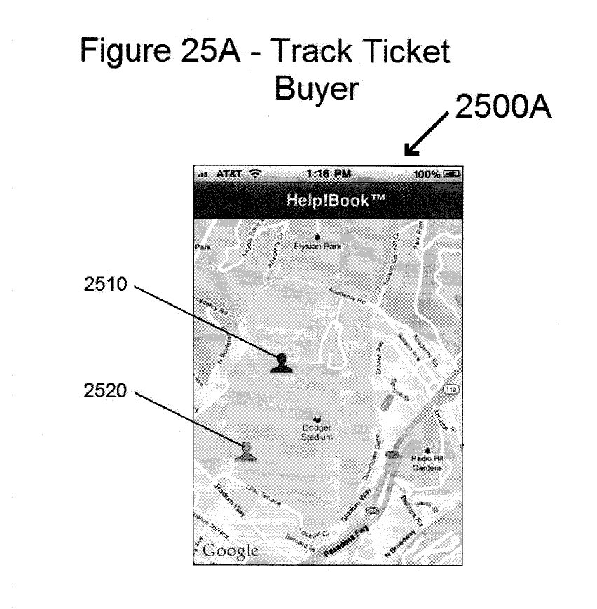

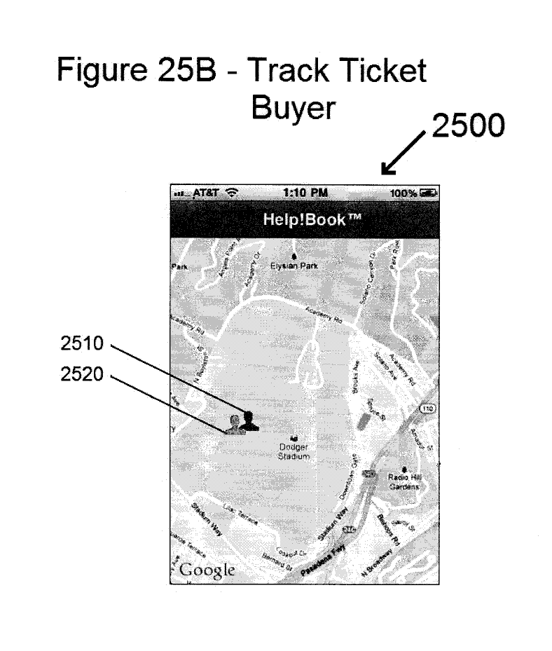

The Provider—see FIG. 24—having been alerted to expect to be contacted by a new Seeker—can view the Locale of the new Seeker by actuating the virtual button 2410, which Linda Rogers chooses to do. This displays a tracking map showing Seeker Judy's Locale as she walks toward the main gate of the stadium and Provider Linda's Locale as she is just pulling into the stadium parking lot—see FIG. 25A.

Linda's mobile communication device rings with the call from Judy Piper—Linda pulls over, parks, and then answers. Judy immediately explains her situation including limited cash. They negotiate a total sale amount—partially to be paid in cash and partially by check. Neither Judy nor Linda are familiar with stadium land marks, but they agree to walk in each other's direction as they both can see on instances of tracking maps on their respective mobile communication devices.

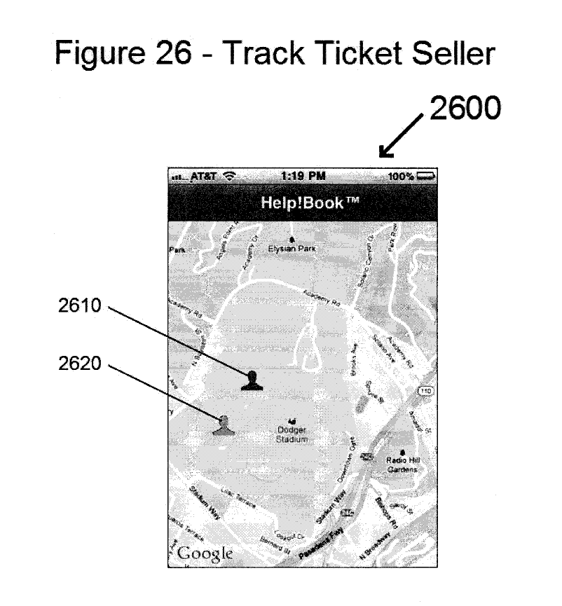

In step 260, the Fulfillment System 150 starts ongoing tracking of the progress of the Provider and/or the Seeker both traveling to meet at an ad hoc rendezvous location. Referring to FIG. 26, the System 150 periodically updates a tracking map as it may appear on Seeker Judy Piper's mobile communication device.

The Seeker and Provider continue walking roughly towards each other—each looking around and at their respective tracking map screens. Referring to FIG. 25B, the System 150 periodically updates a tracking map as it may appear on Provider Linda Roger's mobile communication device. As their geo-locations converge both “smart phones” send a loud audible alert. As they near, Linda sees a woman walking away from the stadium with a worried looking young boy in tow—both staring at a loudly sounding phone. Linda calls out to Judy. They walk towards each other, speak greetings, and then turn to head toward the stadium gate as they finish transacting their business.

Referring to step 270, the Fulfillment System 150 facilitates compensation by logging the transaction whereby the Seeker—Judy Piper—selected the Provider—Linda Rogers. Both Seeker and Provider can subsequently look up the Transaction Log record. Each can separately associate additional annotation with the Transaction Log. In this example, Judy will make a note of Linda's driver license number.

In step 280, the Fulfillment System 150 facilitates follow-up. Linda's Provider Profile in the Database 158 indicates “no follow-up”. Judy's Seeker Profile is set for a next day follow-up, which will turn out to be a brief but heartfelt thank you call.

The Fulfillment System 150 facilitates Loyaltization—step 290—as described above.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computerized method for facilitating at least one followup transaction for a seeker served by a selected proffered provider of an urgent service or goods requested by the seeker, the method comprising:
confirming that an urgent service or goods (URGS) has been provided by a selected provider of at least one urgent service and goods proffered to a seeker; and
facilitating at least one followup transaction between the selected provider and the seeker.

2. The method of claim 1 wherein facilitating the at least one followup transaction includes facilitating compensation of the selected provider.

3. The method of claim 1 wherein facilitating the at least one followup transaction includes facilitating feedback from the seeker to the selected provider.

4. The method of claim 1 wherein facilitating the at least one followup transaction includes facilitating instructions from the selected provider to seeker.

5. The method of claim 1 wherein facilitating the at least one followup transaction includes facilitating loyaltization of the seeker.

6. The method of claim 5 wherein the loyaltization of the seeker includes providing at least one of a reward and a discount to the seeker.

7. The method of claim 1 wherein facilitating the at least one followup transaction includes facilitating loyaltization of the selected provider.

8. The method of claim 7 wherein the loyaltization of the selected provider includes providing at least one of a reward and a discount to the selected provider.

9. The method of claim 7 wherein the loyaltization of the selected provider includes increasing proffering preference of the selected provider.

10. The method of claim 1 further comprising updating at least one of a provider metric and a provider rating associated with the selected provider.

11. A computerized urgent goods and services fulfillment system configured to provide at least one followup transaction for a seeker served by a selected proffered provider of an urgent service or goods requested by the seeker, the fulfillment system comprising:
an urgent goods and services (URGS) database configured to store data associated with a plurality of providers; and
a fulfillment server configured to:
confirm that an urgent service or goods (URGS) has been provided by a selected provider of at least one urgent service and goods proffered to a seeker; and
facilitate at least one followup transaction between the selected provider and the seeker.

12. The fulfillment system of claim 11 wherein facilitating the at least one followup transaction includes facilitating compensation of the selected provider.

13. The fulfillment system of claim 11 wherein facilitating the at least one followup transaction includes facilitating feedback from the seeker to the selected provider.

14. The fulfillment system of claim 11 wherein facilitating the at least one followup transaction includes facilitating instructions from the selected provider to seeker.

15. The fulfillment system of claim 11 wherein facilitating the at least one followup transaction includes facilitating loyaltization of the seeker.

16. The fulfillment system of claim 15 wherein the loyaltization of the seeker includes providing at least one of a reward and a discount to the seeker.

17. The fulfillment system of claim 11 wherein facilitating the at least one followup transaction includes facilitating loyaltization of the selected provider.

18. The fulfillment system of claim 17 wherein the loyaltization of the selected provider includes providing at least one of a reward and a discount to the selected provider.

19. The fulfillment system of claim 17 wherein the loyaltization of the selected provider includes increasing proffering preference of the selected provider.

20. The fulfillment system of claim 11 further comprising updating at least one of a provider metric and a provider rating associated with the selected provider.
